(19) United States
(12) Patent Application Publication
(10) Pub. No.: US 2013/0338260 A1
(43) Pub. Date: Dec. 19, 2013

(54) THERMOPLASTIC MELT-MIXED COMPOSITION WITH EPOXY-CARBOXYLIC ACID COMPOUND HEAT STABILIZER

(71) Applicants: CURTIS R. CENTER, NEWARK, DE (US); YUEFEI TAO, HOCKESSIN, DE (US); JENNIFER L. THOMPSON, NEWARK, DE (US); LECH WILCZEK, WILMINGTON, DE (US); CHEN QIAN ZHAO, NEWARK, DE (US); ANDREW JAY DUNCAN, WILMINGTON, DE (US)

(72) Inventors: CURTIS R. CENTER, NEWARK, DE (US); YUEFEI TAO, HOCKESSIN, DE (US); JENNIFER L. THOMPSON, NEWARK, DE (US); LECH WILCZEK, WILMINGTON, DE (US); CHEN QIAN ZHAO, NEWARK, DE (US); ANDREW JAY DUNCAN, WILMINGTON, DE (US)

(73) Assignee: E I DU PONT DE NEMOURS AND COMPANY, Wilmington, DE (US)

(21) Appl. No.: 13/915,788

(22) Filed: Jun. 12, 2013

Related U.S. Application Data
(60) Provisional application No. 61/658,945, filed on Jun. 13, 2012.

(51) Int. Cl. C08L 77/06; C08J 3/22

(52) U.S. Cl. CPC C08L 77/06; C08J 3/22
USPC 523/351; 523/400

(57) ABSTRACT

Disclosed is a thermoplastic melt-mixed composition including: a) a semicrystalline polyamide resin; b) a polyepoxy compound including at least two or more epoxy groups; the polyepoxy compound having a number average molecular weight of less than 8000; one or more carboxylic acid compounds selected from the group consisting of polyacids, acid alcohols and combinations of these, the carboxylic acid compounds have a number average molecular weight of less than 2000; and optionally, d) reinforcing agent; e) polymeric toughener; and f) further additives.

### CROSS REFERENCE TO RELATED APPLICATIONS

This application claims priority of Provisional Application No. 61/658,945, filed Jun. 13, 2012, now pending.

### FIELD OF INVENTION

The present invention relates to the field of polyamide compositions having improved long-term high temperature aging characteristics.

### BACKGROUND OF INVENTION

High temperature resins based on polyamides possess desirable chemical resistance, processability and heat resistance. This makes them particularly well suited for demanding high performance automotive and electrical/electronics applications. There is a current and general desire in the automotive field to have high temperature resistant structures since temperatures higher than 150° C., even higher than 200° C., are often reached in under-hood areas of automobiles. When plastic parts are exposed to such high temperatures for a prolonged period, such as in automotive under-the-hood applications or in electrical/electronics applications, the mechanical properties generally tend to decrease due to the thermo-oxidation of the polymer. This phenomenon is called heat aging.

In an attempt to improve heat aging characteristics, polyhydric alcohols have been found to give significantly improved heat aging characteristics as disclosed in US patent application publication US 2010-0029819 A1 (Palmer et al). However, molded articles derived from the polyamide compositions comprising the polyhydric alcohols have a tendency to undergo surface whitening upon aging at high humidity; which is an undesirable feature for many applications.

There remains a need for thermoplastic compositions that are suitable for manufacturing articles that exhibit good mechanical properties after long-term high temperature exposure and have desirable visual properties; that is, exhibit no whitening or a low degree of whitening, upon aging at high humidity.

EP 1041109 discloses a polyamide composition comprising a polyamide resin, a polyhydric alcohol having a melting point of 150 to 280° C., that has good fluidity and mechanical strength and is useful in injection welding techniques.

U.S. Pat. No. 5,605,945 discloses a polyamide molding composition with increased viscosity, high thermal stability and favorable mechanical properties comprising a polyamide resin and a diepoxide.

U.S. Pat. No. 4,315,086 discloses a resin composition comprising a polyamide, and a member select from the group consisting of A) liquid diene polymers, B) epoxy compounds and C) compounds having in the molecule both an ethylene carbon-carbon double bond or a carbon-carbon triple bond and a group including an carboxylic acid group.

US patent application publication US-2012-0196962-A1 discloses a thermoplastic molding composition including an aminoacid heat stabilizer.

US patent application publication US-2012-0196961-A1 discloses a thermoplastic molding composition including a polyacid metal salt.

US patent publication 2005/0228109 discloses a thermoplastic composition comprising poly(phenylene oxide), polyamide, an unsaturated carboxylic acid copolymer and/or a polymer with pendant epoxy groups.

U.S. Pat. No. 5,177,144 discloses a rigid molding composition comprising a polyamide, an epoxy having a plurality of epoxy groups, and a copolymer grafted with unsaturated dicarboxylic acid groups.

JP 60181159 A discloses a composition have improved impact resistance prepared by melt-mixing a diepoxide, polyamide and an acid-modified olefin copolymer having unsaturated carboxylic acid groups.

### SUMMARY

Disclosed is a thermoplastic melt-mixed composition comprising:
a) 15 to 89.5 weight percent of a semi-crystalline polyamide resin selected from the group consisting of blends of semi-crystalline polyamides; Group (III) polyamides having a melting point of at least 230° C., and comprising
   (aa) about 20 to about 35 mole percent semi-aromatic repeat units derived from monomers selected from one or more of the group consisting of:
      (i) aromatic dicarboxylic acids having 8 to 20 carbon atoms and aliphatic diamines having 4 to 20 carbon atoms; and
   (bb) about 65 to about 80 mole percent aliphatic repeat units derived from monomers selected from one or more of the group consisting of:
      (ii) an aliphatic dicarboxylic acid having 6 to 20 carbon atoms and said aliphatic diamine having 4 to 20 carbon atoms; and
      (iii) a lactam and/or aminocarboxylic acid having 4 to 20 carbon atoms; and
Group (IV) polyamides comprising
   (cc) about 50 to about 95 mole percent semiaromatic repeat units derived from monomers selected from one or more of the group consisting of:
   (i) aromatic dicarboxylic acids having 8 to 20 carbon atoms and aliphatic diamines having 4 to 20 carbon atoms; and
   (dd) about 5 to about 50 mole percent aliphatic repeat units derived from monomers selected from one or more of the group consisting of:
   (ii) an aliphatic dicarboxylic acid having 6 to 20 carbon atoms and said aliphatic diamine having 4 to 20 carbon atoms; and
   (iii) a lactam and/or aminocarboxylic acid having 4 to 20 carbon atoms;
b) 0.50 to 5.0 weight percent of one or more polyepoxy compound(s) comprising at least two to five epoxy groups; on average, per molecule; the polyepoxy compound having an epoxide equivalent weight of 43 to 4000 g/equivalent as determined by calculation, or if the polyepoxy compound is an oligomer, by titration using ASTM 01652-11 method; and a number average molecular weight of less than 8000;
c) about 025 to 5.0 weight percent of one or more carboxylic acid compounds having melting points of less than 280° C. selected from the group consisting of polyacids, acid alcohols and combinations of these, the carboxylic acid compounds having a number average molecular weight of less than 2000;
d) 10 to 60 weight percent of reinforcing agent;
e) 0 to 30 weight percent polymeric toughener; and
f) 0 to 10 weight percent of further additives;
   wherein the weight per cents of components a), b), c) d) e) and f) are based on the total weight of the thermoplastic melt-mixed composition and wherein 2 mm thick test bars, prepared from said melt-mixed composition and exposed at a test temperature of 230° C. for a test period of 1000 hours, in an atmosphere of air, and tested according to ISO 527-2/1BA, have on average, a retention of tensile strength of at least 30 percent, as compared with that of an unexposed control of identical composition and shape.

Further disclosed is a process for providing a thermoplastic melt-mixed composition comprising:

A) melt-blending:
a) 15 to 89.5 weight percent of a semi-crystalline polyamide resin selected from the group consisting of blends of semi-crystalline polyamides; Group (III) polyamides having a melting point of at least 230° C., and comprising
   (aa) about 20 to about 35 mole percent semi-aromatic repeat units derived from monomers selected from one or more of the group consisting of:
      (i) aromatic dicarboxylic acids having 8 to 20 carbon atoms and aliphatic diamines having 4 to 20 carbon atoms; and
   (bb) about 65 to about 80 mole percent aliphatic repeat units derived from monomers selected from one or more of the group consisting of:
      (ii) an aliphatic dicarboxylic acid having 6 to 20 carbon atoms and said aliphatic diamine having 4 to 20 carbon atoms; and
      (iii) a lactam and/or aminocarboxylic acid having 4 to 20 carbon atoms; and
Group (IV) polyamides comprising
   (cc) about 50 to about 95 mole percent semiaromatic repeat units derived from monomers selected from one or more of the group consisting of:
   (i) aromatic dicarboxylic acids having 8 to 20 carbon atoms and aliphatic diamines having 4 to 20 carbon atoms; and
   (dd) about 5 to about 50 mole percent aliphatic repeat units derived from monomers selected from one or more of the group consisting of:
   (ii) an aliphatic dicarboxylic acid having 6 to 20 carbon atoms and said aliphatic diamine having 4 to 20 carbon atoms; and
   (iii) a lactam and/or aminocarboxylic acid having 4 to 20 carbon atoms;
   c) about 0.25 to 5.0 weight percent of one or more carboxylic acid compounds having melting points of less than 280° C., selected from the group consisting of polyacids, acid alcohols and combinations of these, the carboxylic acid compounds having a number average molecular weight of less than 2000;
   d) 10 to 60 weight percent of reinforcing agent;
   e) 0 to 30 weight percent polymeric toughener; and
   f) 0-10 weight percent of further additives;
   to provide a polyamide-polyacid blend; and
   B) melt-blending said polyamide-polyacid blend with
   b) 0.5 to 5.0 weight percent of one or more polyepoxy compound(s) comprising at least two to five epoxy groups, on average, per molecule; the polyepoxy compound having an epoxide equivalent weight of 43 to 4000 g/equivalent as determined by calculation, or if the polyepoxy compound is an oligomer, by titration using ASTM D1652-11 method; and a number average molecular weight of less than 8000; and
      wherein the weight percents of components a), b), c), d) e) and f) are based on the total weight of the thermoplastic melt-mixed composition.

Another embodiment is a process for providing a thermoplastic melt-mixed composition comprising:

A) melt-blending:
a) 15 to 89.5 weight percent of a semi-crystalline polyamide resin selected from the group consisting of blends of semi-crystalline polyamides; Group (ID) polyamides having a melting point of at least 230° C., and comprising
(aa) about 20 to about 35 mole percent semi-aromatic repeat units derived from monomers selected from one or more of the group consisting of:
   (i) aromatic dicarboxylic acids having 8 to 20 carbon atoms and aliphatic diamines having 4 to 20 carbon atoms; and
(bb) about 65 to about 80 mole percent aliphatic repeat units derived from monomers selected from one or more of the group consisting of:
   (ii) an aliphatic dicarboxylic acid having 6 to 20 carbon atoms and said aliphatic diamine having 4 to 20 carbon atoms; and
   (iii) a lactam and/or aminocarboxylic acid having 4 to 20 carbon atoms; and
Group (IV) polyamides comprising
(cc) about 50 to about 95 mole percent semiaromatic repeat units derived from monomers selected from one or more of the group consisting of:
(i) aromatic dicarboxylic acids having 8 to 20 carbon atoms and aliphatic diamines having 4 to 20 carbon atoms; and
(dd) about 5 to about 50 mole percent aliphatic repeat units derived from monomers selected from one or more of the group consisting of:
(ii) an aliphatic dicarboxylic acid having 6 to 20 carbon atoms and said aliphatic diamine having 4 to 20 carbon atoms; and
(iii) a lactam and/or aminocarboxylic acid having 4 to 20 carbon atoms;
b) 0.5 to 5.0 weight percent of one or more polyepoxy compound(s) comprising at least two to five epoxy groups, on average, per molecule; the polyepoxy compound having an epoxide equivalent weight of 43 to 4000 g/equivalent as determined by calculation, or if the polyepoxy compound is an oligomer, by titration using ASTM D1652-11 method; and a number average molecular weight of less than 8000;
c) about 0.25 to 5.0 weight percent of one or more carboxylic acid compounds having melting points of less than 280° C., selected from the group consisting of polyacids, acid alcohols and combinations of these, the carboxylic acid compounds having a number average molecular weight of less than 2000;
d) 10 to 60 weight percent of reinforcing agent;
e) 0 to 30 weight percent polymeric toughener; and
f) 0-10 weight percent of further additives;
   wherein the weight percents of components a), b), c), d) e) and
f) are based on the total weight of the thermoplastic melt-mixed composition and wherein components b) polyepoxy compound and c) carboxylic acid compounds are added simultaneously during the melt-blending.

### DETAILED DESCRIPTION

Herein melting points and glass transitions are as determined with differential scanning calorimetry (DSC) at a scan rate of 10° C./min in the first heating scan, wherein the melting point is taken at the maximum of the endothermic peak and the glass transition, if evident, is considered the mid-point of the change in enthalpy.

For the purposes of the description, unless otherwise specified, “high-temperature” means a temperature at or higher than 210° C., and most preferably at or higher than 230° C.

In the present invention, unless otherwise specified, “long-term” refers to an aging period equal or longer than 500 hrs.

As used herein, the term “high heat stability”, as applied to the polyamide composition disclosed herein or to an article made from the composition, refers to the retention of physical properties (for instance, tensile strength) of 2 mm thick molded test bars consisting of the polyamide composition that are exposed to air oven aging (AOA) conditions at a test temperature at 230° C. for a test period of at least 500 h, in an atmosphere of air, and then tested according to ISO 527-2/1BA method. The physical properties of the test bars are compared to that of unexposed controls that have identical composition and shape, and are expressed in terms of “% retention”. In a preferred embodiment the test temperature is at 230° C., the test period is at 1000 hours and the exposed test bars have a % retention of tensile strength of at least 30%. Herein “high heat stability” means that said molded test bars, on average, meet or exceed a retention for tensile strength of 30% when exposed at a test temperature at 230° C. for a test period of at least 1000 h. Compositions exhibiting a higher retention of physical properties for a given exposure temperature and time period have better heat stability.

The terms “at 170° C.,” “at 210° C.” and “at 230° C.” refer to the nominal temperature of the environment to which the test bars are exposed; with the understanding that the actual temperature may vary by +/−2° C. from the nominal test temperature.

The term “consist essentially of” means the embodiment necessarily includes the listed ingredients and is open to unlisted ingredients that do not materially affect the basic and novel properties of the invention. Herein, for instance, the term as applied to the thermoplastic composition, means the thermoplastic composition includes the listed ingredients, and may include other ingredients in small amounts, so long as the additional ingredients do not materially affect the basic and novel properties of the invention.

One embodiment is a thermoplastic melt-mixed composition comprising:

a) 15 to 89.5 weight percent of a semicrystalline polyamide resin having a melting point;

b) 0.25 to 5.0 weight percent of one or more polyepoxy compound comprising at least two or more epoxy groups; the polyepoxy compound having a epoxide equivalent weight of 43 to 4000 g/equivalent as determined by calculation, or if the polyepoxy compound is an oligomer, by titration using ASTM D1652-11 method; and a number average molecular weight (Mn) of less than 8000;

c) about 0.25 to 5.0 weight percent of one or more carboxylic acid compounds selected from the group consisting of polyacids, acid alcohols and combinations of these, the carboxylic acid compounds have a number average molecular weight of less than 2000;

d) 10 to 60 weight percent of reinforcing agent;

e) 0 to 30 weight percent polymeric toughener, and

f) 0 to 10 weight percent of further additives;

wherein the weight percents of components a), b), c), d) e) and f) are based on the total weight of the thermoplastic melt-mixed composition.

Preferred embodiments are thermoplastic melt-mixed compositions wherein 2 mm thick test bars, prepared from said melt-mixed compositions and exposed at a test temperature of 230° C. for a test period of 1000 hours, in an atmosphere of air, and tested according to ISO 527-2/1BA, have on average, a retention of tensile strength of at least 30 percent, as compared with that of an unexposed control of identical composition and shape.

### Polyamide Resin

The thermoplastic polyamide compositions of various embodiments of the invention comprise a polyamide resin. The polyamide resins are condensation products of one or more dicarboxylic acids and one or more diamines, and/or one or more aminocarboxylic acids, and/or ring-opening polymerization products of one or more cyclic lactams. Suitable cyclic lactams are caprolactam and laurolactam. Polyamides may be fully aliphatic or semi-aromatic.

Fully aliphatic polyamides are formed from aliphatic and alicyclic monomers such as diamines, dicarboxylic acids, lactams, aminocarboxylic acids, and their reactive equivalents. A suitable aminocarboxylic acid is 11-21) aminododecanoic acid. Suitable lactams are caprolactam and laurolactam. In the context of this invention, the term “fully aliphatic polyamide” also refers to copolymers derived from two or more such monomers and blends of two or more fully aliphatic polyamides. Linear, branched, and cyclic monomers may be used.

Carboxylic acid monomers comprised in the fully aliphatic polyamides include, but are not limited to aliphatic carboxylic acids, such as for example adipic acid (C6), pimelic acid (C7), suberic acid (C8), azelaic acid (C9), decanedioic acid (C10), dodecanedioic acid (C12), tridecanedioic acid (C13), tetradecanedioic acid (C14), pentadecanedioic acid (C15), hexadecanedioic acid (C16) and octadecanedioic acid (C18). Diamines can be chosen among diamines having four or more carbon atoms, including, but not limited to tetramethylene diamine, hexamethylene diamine, octamethylene diamine, decamethylene diamine, dodecamethylene diamine, 2-methylpentamethylene diamine, 2-ethyltetramethylene diamine, 2-methyloctamethylenediamine; trimethylhexamethylenediamine, meta-xylylene diamine, and/or mixtures thereof.

The semi-aromatic polyamide is a homopolymer, a copolymer, a terpolymer or more advanced polymers formed from monomers containing aromatic groups. One or more aromatic carboxylic acids may be terephthalate or a mixture of terephthalate with one or more other carboxylic acids, such as isophthalic acid, phthalic acid, 2-methyl terephthalic acid and naphthalic acid. In addition, the one or more aromatic carboxylic acids may be mixed with one or more aliphatic dicarboxylic acids, as disclosed above. Alternatively, an aromatic diamine such as meta-xylylene diamine (MXD) can be used to provide a semi-aromatic polyamide, an example of which is MXD6, a homopolymer comprising MXD and adipic acid.

Preferred polyamides disclosed herein are homopolymers or copolymers wherein the term copolymer refers to polyamides that have two or more amide and/or diamide molecular repeat units. The homopolymers and copolymers are identified by their respective repeat units. For copolymers disclosed herein, the repeat units are listed in decreasing order of mole % repeat units present in the copolymer. The following list exemplifies the abbreviations used to identify monomers and repeat units in the homopolymer and copolymer polyamides (PA):
HMD hexamethylene diamine (or 6 when used in combination with a diacid)
T Terephthalic acid
AA Adipic acid
DMD Decamethylenediamine
6 [symbol] -Caprolactam
ODA Decanedioic acid
DDDA Dodecanedioic acid
TDDA Tetradecanedioic acid
HDDA Hexadecanedioic acid
ODDA Octadecanedioic acid
I Isophthalic acid
MXD meta-xylylene diamine
TMD 1,4-tetramethylene diamine
4T polymer repeat unit formed from TMD and T
6T polymer repeat unit formed from HMD and T
DT polymer repeat unit formed from 2-MPMD and T
MXD6 polymer repeat unit formed from MXD and AA
66 polymer repeat unit formed from HMD and AA
10T polymer repeat unit formed from DMD and T
410 polymer repeat unit formed from TMD and DDA
510 polymer repeat unit formed from 1,5-pentanediamine and DDA
610 polymer repeat unit formed from HMD and DDA
612 polymer repeat unit formed from HMD and DDDA
614 polymer repeat unit formed from HMD and TDDA
616 polymer repeat unit formed from HMD and HDDA
618 polymer repeat unit formed from HMO and ODDA
6 polymer repeat unit formed from ε-caprolactam
11 polymer repeat unit formed from 11-aminoundecanoic acid
12 polymer repeat unit formed from 12-aminododecanoic acid

Note that in the art the term “6” when used alone designates a polymer repeat unit formed from E-caprolactam. Alternatively “6” when used in combination with a diacid such as T, for instance 6T, the “6” refers to HMD. In repeat units comprising a diamine and diacid, the diamine is designated first.

Furthermore, when “6” is used in combination with a diamine, for instance 66, the first “6” refers to the diamine HMD, and the second “6” refers to adipic acid. Likewise, repeat units derived from other amino acids or lactams are designated as single numbers designating the number of carbon atoms.

In one embodiment the polyamide composition comprises a one or more polyamides selected from the group consisting of

Group (I) polyamides having a melting point of less than 210° C., and comprising an aliphatic or semiaromatic polyamide selected from the group consisting of poly(pentamethylene decanediamide) (PA510), poly(pentamethylene dodecanediamide) (PA512), poly(ε-caprolactam/hexamethylene hexanediamide) (PA6/66), poly(ε-caprolactam/hexamethylene decanediamide) (PA6/610), poly(ε-caprolactam/hexamethylene dodecanediamide) (PA6/612), poly(hexamethylene tridecanediamide) (PA613), poly(hexamethylene pentadecanediamide) (PA615), poly(ε-caprolactam/tetramethylene terephthalamide) (PA6/4T), poly(ε-caprolactam/hexamethylene terephthalamide) (PA6/6T), poly-caprolactam/decamethylene terephthalamide) (PA6/10T), poly(6-caprolactam/dodecamethylene terephthalamide) (PA6/12T), poly(hexamethylene decanediamide/hexamethylene terephthalamide) (PA610/6T), poly(hexamethylene dodecanediamide/hexamethylene terephthalamide) (PA612/6T), poly(hexamethylene tetradecanediamide/hexamethylene terephthalamide) (PA614/6T), poly(ε-caprolactam/hexamethylene isophthalamide/hexamethylene terephthalamide) (PA6/6I/6T), poly(ε-caprolactam/hexamethylene hexanediamide/hexamethylene decanediamide) (PA6/66/610), poly(ε-caprolactam/hexamethylene hexanediamide/hexamethylene dodecanediamide) (PA6/66/612), poly(E-caprolactam/hexamethylene hexanediamide/hexamethylene decanediamide/hexamethylene dodecanediamide) (PA6/66/610/612), poly(2-methylpentamethylene hexanediamide/hexamethylene hexanediamide/hexamethylene terephthamide) (PA D6/66/6T), poly(2-methylpentamethylene hexanediamide/hexamethylene hexanediamide/) (PA D6/66), poly(decamethylene decanediamide) (PA1010), poly(decamethylene dodecanediamide) (PA1012), poly(decamethylene decanediamide/decamethylene terephthalamide) (PA1010/10T) poly(decamethylene decanediamide/dodecamethylene decanediamide/decamethylene terephthalamide/dodecamethylene terephthalamide (PA1010/1210/10T/12T), poly(11-aminoundecanamide) (PA11), poly(11-aminoundecanamide/tetramethylene terephthalamide) (PA11/4T), poly(11-aminoundecanamide/hexamethylene terephthalamide) (PA11/6T), poly(1′-aminoundecanamide/decamethylene terephthalamide) (PA11/10T), poly(11-aminoundecanamide/dodecamethylene terephthalamide) (PA11/12T), poly(12-aminododecanamide) (PA12), poly(12-aminododecanamide/tetramethylene terephthalamide) (PA12/4T), poly(12-aminododecanamide/hexamethylene terephthalamide) (PA12/6T), poly(12-aminododecanamide/decamethylene terephthalamide) (PA12/10T) poly(dodecamethylene dodecanediamide) (PA1212), poly(dodecamethylene dodecanediamide/dodecamethylene dodecanediamide/dodecamethylene terephthalamide)) (PA1212/12T), poly(hexamethylene hexadecanediamide) (PA616), and poly(hexamethylene octadecanediamide) (PA618); Group (II) polyamides having a melting point of at least 210° C., and comprising an aliphatic polyamide selected from the group consisting of poly(tetramethylene hexanediamide) (PA46), poly(ε-caprolactam) (PA 6), poly(hexamethylene hexanediamide/(ε-caprolactam/) (PA 66/6) poly(hexamethylene hexanediamide) (PA 66), poly(hexamethylene hexanediamide/hexamethylene decanediamide) (PA66/610), poly(hexamethylene hexanediamide/hexamethylene dodecanediamide) (PA66/612), poly(hexamethylene hexanediamide/decamethylene decanediamide) (PA66/1010), poly(hexamethylene decanediamide) (PA610), poly(hexamethylene dodecanediamide) (PA612), poly(hexamethylene tetradecanediamide) (PA614), and poly(tetramethylene hexanediamide/2-methylpentamethylene hexanediamide) (PA46/D6); wherein within Group (II) Polyamides are Group (IIA) Polyamides having a melting point of at least 210° C. and less than 230° C. and Group (IIB) Polyamides having a melting point of 230° C. or greater;
Group (III) polyamides having a melting point of at least 230° C., and comprising
(aa) about 20 to about 35 mole percent semiaromatic repeat units derived from monomers selected from one or more of the group consisting of:
   (i) aromatic dicarboxylic acids having 8 to 20 carbon atoms and aliphatic diamines having 4 to 20 carbon atoms; and
(bb) about 65 to about 80 mole percent aliphatic repeat units derived from monomers selected from one or more of the group consisting of:
   (ii) an aliphatic dicarboxylic acid having 6 to 20 carbon atoms and said aliphatic diamine having 4 to 20 carbon atoms; and
   (iii) a lactam and/or aminocarboxylic acid having 4 to 20 carbon atoms;
      Group (IV) polyamides comprising
(cc) about 50 to about 95 mole percent semiaromatic repeat units derived from monomers selected from one or more of the group consisting of:
(i) aromatic dicarboxylic acids having 8 to 20 carbon atoms and aliphatic diamines having 4 to 20 carbon atoms; and
(dd) about 5 to about 50 mole percent aliphatic repeat units derived from monomers selected from one or more of the group consisting of:
(ii) an aliphatic dicarboxylic acid having 6 to 20 carbon atoms and said aliphatic diamine having 4 to 20 carbon atoms; and
(iii) a lactam and/or aminocarboxylic acid having 4 to 20 carbon atoms; and
   Group (V) polyamides having a melting point of at least 260° C., comprising
(ee) greater than 95 mole percent semiaromatic repeat units derived from monomers selected from one or more of the group consisting of:
(i) aromatic dicarboxylic acids having 8 to 20 carbon atoms and aliphatic diamines having 4 to 20 carbon atoms; and
(ff) less than 5 mole percent aliphatic repeat units derived from monomers selected from one or more of the group consisting of:
(ii) an aliphatic dicarboxylic acid having 6 to 20 carbon atoms and said aliphatic diamine having 4 to 20 carbon atoms;
(iii) a lactam and/or aminocarboxylic acid having 4 to 20 carbon atoms.

Group (I) polyamides may have semiaromatic repeat units to the extent that the melting point is less than 210° C. and generally the semiaromatic polyamides of the group have less than 40 mole percent semiaromatic repeat units. Semiaromatic repeat units are defined as those derived from monomers selected from one or more of the group consisting of: aromatic dicarboxylic acids having 8 to 20 carbon atoms and aliphatic diamines having 4 to 20 carbon atoms.

Another embodiment is a molded or extruded thermoplastic article wherein said polyimide resin is selected from Group (III) polyamides selected from the group consisting of poly(tetramethylene hexanediamide/tetramethylene terephthalamide) (PA46/4T), poly(tetramethylene hexanediamide/hexamethylene terephthalamide) (PA46/6T), poly(tetramethylene hexanediamide/2-methylpentamethylene hexanediamide/decamethylene terephthalamide) PA46/06/10T), poly(hexamethylene hexanediamide/hexamethylene terephthalamide) (PA66/6T), poly(hexamethylene hexanediamide/hexamethylene isophthalamide/hexamethylene terephthalamide PA66/61/6T, and poly(hexamethylene hexanediamide/2-methylpentamethylene hexanediamide/hexamethylene terephthalamide (PA66/D6/6T); and a most preferred Group (III) polyamide is PA 66/6T.

Another embodiment is a molded or extruded thermoplastic article wherein said polyamide resin is selected from Group (IV) polyamides selected from the group consisting of poly(tetramethylene terephthalamide/hexamethylene hexanediamide) (PA4T/66), poly(tetramethylene terephthalamide/ε-caprolactam) (PA4T/6), poly(tetramethylene terephthalamide/hexamethylene dodecanediamide) (PA4T/612), poly(tetramethylene terephthalamide/2-methylpentamethylene hexanediamide/hexamethylene hexanediamide) (PA4T/06166), poly(hexamethylene terephthalamide/2-methylpentamethylene terephthalamide/hexamethylene hexanediamide) (PA6T/DT/66), poly(hexamethylene terephthalamide/hexamethylene hexanediamide) PA6T/66, poly(hexamethylene terephthalamide/hexamethylene decanediamide) (PA6T/610), poly(hexamethylene terephthalamide/hexamethylene tetradecanediamide) (PA6T/614), poly(nonamethylene terephthalamide/nonamethylene decanediamide) (PAST/910), poly(nonamethylene terephthalamide/nonamethylene dodecanediamide) (PA9T1912), poly(nonamethylene terephthalamide/11-aminoundecanamide) (PAST/11), poly(nonamethylene terephthalamide/12-aminododecanamide) (PA9T/12), poly(decamethylene terephthalamide/11-aminoundecanamide) (PA 10T/11), poly(decamethylene terephthalamide/12-aminododecanamide) (PA10T/12) poly(decamethylene terephthalamide/decamethylene decanediamide) (PA10T/1010), poly(decamethylene terephthalamide/decamethylene dodecanediamide) (PA10T/1012), poly(decamethylene terephthalamide/tetramethylene hexanediamide) (PA10T/46), poly(decamethylene terephthalamide/ε-caprolactam) (PA10T/6), poly(decamethylene terephthalamide/hexamethylene hexanediamide) (PA10T/66), poly(dodecamethylene terephthalamide/dodecamethylene dodecanediamide) (PA12T/1212), poly(dodecamethylene terephthalamide/ε-caprolactam) (PA12T/6), and poly(dodecamethylene terephthalamide/hexamethylene hexanediamide) (PA12T/66); and a most preferred Group (IV) polyamide is PA6T/66.

Another embodiment is a molded or extruded thermoplastic article wherein said polyamide resin is selected from Group (V) polyamides selected from the group consisting of poly(tetramethylene terephthalamide/2-methylpentamethylene terephthalamide) PA4T/DT, poly(tetramethylene terephthalamide/hexamethylene terephthalamide) PA4T/6T, poly(tetramethylene terephthalamide/decamethylene terephthalamide) PA4T/10T, poly(tetramethylene terephthalamide/dodecamethylene terephthalamide)PA4T/12T, poly(tetramethylene terephthalamide/2-methylpentamethylene terephthalamide/hexamethylene terephthalamide) (PA4T/DT/6T), poly(tetramethylene terephthalamide/hexamethylene terephthalamide/2-methylpentamethylene terephthalamide) (PA4T/6T/DT), poly(hexamethylene terephthalamide/2-methylpentamethylene terephthalamide) (PA6T/DT), poly(hexamethylene hexanediamide/hexamethylene isophthalamide) (PA 6T/6I), poly(hexamethylene terephthalamide/decamethylene terephthalamide) PA6T/10T, poly(hexamethylene terephthalamide/dodecamethylene terephthalamide) (PA6T/12T), poly(hexamethylene terephthalamide/2-methylpentamethylene terephthalamide/poly(decamethylene terephthalamide) (PA6T/DT/10T), poly(hexamethylene terephthalamide/decamethylene terephthalamide/dodecamethylene terephthalamide) (PA6T/10T/12T), poly(decamethylene terephthalamide) (PA10T), poly(decamethylene terephthalamide/tetramethylene terephthalamide) (PA10T/4T), poly(decamethylene terephthalamide/2-methylpentamethylene terephthalamide) (PA10T/DT), poly(decamethylene terephthalamide/dodecamethylene terephthalamide) (PA10T/12T), poly(decamethylene terephthalamide/2-methylpentamethylene terephthalamide/(decamethylene terephthalamide) (PA10T/DT/12T). poly(dodecamethylene terephthalamide) (PA12T), poly(dodecamethylene terephthalamide)/tetramethylene terephthalamide) (PAl21T/4T), poly(dodecamethylene terephthalamide)/hexamethylene terephthalamide) PA12T/16T, poly(dodecamethylene terephthalamide)/decamethylene terephthalamide) (PA12T/10T), and poly(dodecamethylene terephthalamide)/2-methylpentamethylene terephthalamide) (PA12T/DT); and a most preferred Group (V) Polyamide is PA6T/DT.

In various embodiments the polyamide is a Group (I) Polyamide, Group (II) Polyamide, Group (III) Polyamide, Group (IV) Polyamide, or Group (V) Polyamide, respectively.

The polyamides may also be blends of two or more polyamides. Preferred blends include those selected from the group consisting of Group (I) and Group (II) Polyamides; Group (I) and Group (III) Polyamide, Group (II) and Group (III) Polyamides, Group (II) and Group (IV) Polyamides, Group (II) and Group (V) Polyamides, and Group (IV) and Group (V) Polyamides.

A preferred blend includes Group (II) and (V) Polyamides, and a specific preferred blend includes poly(hexamethylene hexanediamide) (PA 66) and poly(hexamethylene terephthalamide/2-methylpentamethylene terephthalamide) (PA 6T/DT).

Another preferred blend includes Group (II) and Group (III) Polyamides and a specific preferred blend includes poly(ε-caprolactam) and poly(hexamethylene hexanediamide/hexamethylene terephthalamide (PA6+PA66/6T). Other preferred blends are poly(hexamethylene hexanediamide) and poly(hexamethylene hexanediamide/hexamethylene terephthalamide (PA 66+PA 66/6T) and poly(hexamethylene hexanediamide/hexamethylene terephthalamide and poly(caprolactam) (PA 66/6T+PA 6).

Another preferred blend of polyamides includes two or more polyamides from Group (II) polyamides. Specific preferred blends include poly(hexamethylene hexanediamide) and poly(caprolactam) (PA 66+PA 6); and poly(hexamethylene hexanediamide), poly(hexamethylene hexanediamide/hexamethylene terephthalamide and poly(caprolactam) (PA 66+PA 66/6T+PA 6). In various embodiment blends preferably have 1 to 15, 1 to 10 and 1 to 5 weight percent PA 6, based on the total weight of the thermoplastic melt-mixed composition.

In a preferred embodiment the component a) semi-crystalline polyamide resin is selected from the group consisting of blends of semi-crystalline polyamides; Group (III) polyamides having a melting point of at least 230° C. and Group (IV) polyamides as disclosed herein.

In various embodiments 29 to 89.5, 49 to 89.5, or 55 to 89.5 weight percent of polyamide resin is present in the thermoplastic polyamide composition. In preferred embodiments there is less than 5 weight percent polyphenylene oxide present in the thermoplastic composition, and preferably, no polyphenylene oxide is present.

The polyamide resin has a number average molecular weight of at least 5000, and preferably greater than 10,000, as determined with size exclusion chromatography in hexafluoroisopropanol.

### Polyepoxy Compound

Component b) is 0.5 to 5.0, and preferably 0.5 to 4.0, 1.0 to 4.0 and 1.0 to 3.0 weight percent of one or more polyepoxy compound comprising at least two or more epoxy groups, preferably 2 to 5, 2 to 4.5 and 2 to 4 epoxy groups, on average, per molecule; the polyepoxy compound having a epoxide equivalent weight of 43 to 4000 g/equivalent, and preferably 43 to 1000, 70 to 1000, 70 to 500, 70 to 200, 70 to 190 and 70 to 180 g/equivalent, as determined by calculation, or if the polyepoxy compound is an oligomer, by titration using ASTM 01652-11 method; and a number average molecular weight (Mₙ) of less than 8000. In various embodiments the number average molecular weight (Mₙ) is less than 2000, less than 1000, and less than 400. Preferably the polyepoxy compound has a Mn of less than 1000.

The average number of epoxy groups per molecule is determined by calculation or if the polyepoxy compound is an oligomer, by dividing the number average molecular weight by the epoxy equivalent weight.

Examples of the polyepoxy compounds useful in the invention include 1,4-butanediol diglycidyl ether (BDE), bisphenol A diglycidyl ether (BADE), bisphenol F diglycidyl ether (BFDE), trimethylolpropane triglycidyl ether (TTE), hydrogenated bisphenol A type epoxy resin, brominated epoxy resin, cycloaliphatic epoxy resin, and glycidyl amine type epoxy resin. Further examples of polyepoxides which can be used in the present invention include polyepoxides made by epoxidation of polyenes such as 1,3-butadiene diepoxide (MW 86.09, epoxy equivalent weight=43.05), 1,2,7,8-diepoxyoctane, 1,2,5,6-diepoxycyclooctane, 4-vinyl-1-cyclohexene diepoxide, and epoxidized polyisoprene copolymers such as commercial resins available from Shell Chemical Company, e.g., EKP 206 and EKP 207 (MW 6,000, epoxy equivalent weight 670). Other useful polyepoxides are the EPON™ Resins, derived from a liquid epoxy resin and bisphenol-A, available from Momentive, Inc., Columbus, Ohio. The epoxy resin is not limited to these, and these may be used singly or in a combination of two or more kinds.

In a preferred embodiment the polyepoxy compound is trimethylolpropane triglycidyl ether (TTE). The theoretical lowest epoxy equivalent weight for pure TTE is about 101. In practice the epoxy equivalent weight is about 138 to 154 due to oligomerization-type side reactions.

### Carboxylic Acid Compounds

Component c) is 0.25 to 5.0 weight percent, and in various embodiments 0.5 to 4.0, 0.5 to 3.0, 1.0 to 4.0, 1.0 to 3.0 and 1.0 to 2.0 weight percent, of one or more carboxylic acid compounds selected from the group consisting of polyacids, acid alcohols and combinations of these, the carboxylic acid compounds having melting points of less than 280° C. and preferably less than 250° C., and a number average molecular weight of less than 2000, and preferably up to 1000, 500, or 300,

The carboxylic acid compounds can be used as such or in the form of acid salts, Preferably the carboxylic acid compounds include acid or acid salts. The term “carboxylic acid compounds,” “polyacids” and “acid alcohols” do not include compounds that have primary amine, secondary or tertiary amine functionality. Preferably the carboxylic acid compounds do not comprise a nonaromatic site of carbon-carbon unsaturation, e.g., carbon-carbon double bonds.

### Polyacids

The term “carboxylic acid compounds” include polyacids comprising two or more carboxylic acid groups separated by at least two carbon atoms. The polyacids are linked to one another by linking groups comprising two or more carbon atoms. In one embodiment the linking groups comprise 2 to 12 carbon atoms and preferably 2 to 10 carbon atoms. In various other embodiments the linking group comprises 2 to 4, 2 to 3, and 2 carbon atoms. Linking groups may include one or more heteroatoms such as tertiary nitrogen, oxygen or sulfur. The linking group can optionally be substituted with amide, ester, or ether functionality. For instance the polyacid may comprise a polyester oligomer having carboxylic acid end groups; a polyether having carboxylic acid end groups; for example carboxylic acid capped poly(ethylene glycol); In various embodiments the polyacid is selected from the group consisting of a polyamide oligomer, polyether oligomer or polyester oligomer, said oligomer having a number average molecular weight less than 5000, as determined with SEC.

Preferably the polyacid has an equivalent weight of 45 to less than 2000, and more preferably 59 to 1000, 59 to 500, 59 to 300 and 59 to 200. The equivalent weight of the polyacid is determined by calculation, or if the polyacid is an oligomer or polymer, by titration using ASTM 974 method.

Polyacids include diacids, triacids, tetraacids, low molecular weight polyacrylic acids and poly(methacrylic acids); arylalkyl polyacids and aromatic polyacids.

The dicarboxylic acids include for example aliphatic dicarboxylic acids, such as oxalic acid, malonic acid, succinic acid, glutaric acid, adipic acid, pimelinic acid, suberic acid, azelaic acid, sebacic acid, 1,11-undecanedioic acid, 1,12-dodecanedioic acid, cis- and trans-cyclohexane-1,2-dicarboxylic acid; cis- and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid. It is also possible additionally to use aromatic dicarboxylic acids, such as phthalic acid, isophthalic acid or terephthalic acid, for example.

Said dicarboxylic acids may also be substituted by one or more radicals selected from C₁-C₁₀ alkyl groups, such as methyl, ethyl, n-propyl, isopropyl; n-butyl, isobutyl, sec-butyl, tert-butyl, n-pentyl, isopentyl; sec-pentyl; neopentyl, 1,2-dimethylpropyl, isoamyl, n-hexyl, isohexyl, sec-hexyl, n-heptyl, isoheptyl, n-octyl; 2-ethylhexyl, trimethylpentyl, n-nonyl or n-decyl, for example, C₃-C₁₂ cycloalkyl groups; such as cyclopropyl; cyclobutyl, cyclopentyl, cyclohexyl, cycloheptyl, cyclooctyl, cyclononyl, cyclodecyl, cycloundecyl and cyclododecyl, for example; preference is given to cyclopentyl, cyclohexyl and cycloheptyl; alkylene groups such as methylene or ethylidene or C₆-C₁₄ aryl groups such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, for example, preferably phenyl, 1-naphthyl and 2-naphthyl, more preferably phenyl. Exemplary representatives of substituted dicarboxylic acids that may be mentioned include the following, 2-methylmalonic acid, 2-ethylmalonic acid, 2-phenylmalonic acid, methylsuccinic acid, 2-ethylsuccinic acid, 2-phenylsuccinic acid, itaconic acid, 3,3-dimethylglutaric acid.

It is also possible to use mixtures of two or more of the aforementioned dicarboxylic acids. Within the context of the present invention it is also possible to use a mixture of a dicarboxylic acid and one or more of its derivatives. Likewise possible within the context of the present invention is to use a mixture of two or more different derivatives of one or more dicarboxylic acids.

Examples of tricarboxylic or polycarboxylic acids that can be used include aconitic acid, 1,3,5-cyclohexanetricarboxylic acid, 1,2,4-benzenetricarboxylic acid, 1,3,5-benzenetricarboxylic acid, 1,2,4,5-benzenetetracarboxylic acid (pyromellitic acid) and also mellitic acid and low molecular weight polyacrylic acids.

Within the context of the present invention it is also possible to use a mixture of a tricarboxylic or polycarboxylic acid and one or more of its derivatives, such as a mixture of pyromellitic acid and pyromellitic salts, for example. It is likewise possible within the context of the present invention to use a mixture of two or more different derivatives of one or more tricarboxylic or polycarboxylic acids, such as a mixture of 1,3,5-cyclohexanetricarboxylic acid and pyromellitic salts, for example.

In one embodiment the carboxylic acid compound is a polyacid, and preferably the polyacid is present at 0.5 to 1.5 weight percent, in the thermoplastic melt-mixed composition. Preferably the polyacid has a melting point of less than 250° C.

In one embodiment the polyacids for the invention include those selected from the group consisting of decanedioic acid and dodecanedioic acid (DDDR).

### Acid Alcohols

The term “carboxylic acid compounds” further include acid alcohols.

Acid alcohols have at least one carboxylic acid and at least one hydroxyl group separated by at least one carbon atom; and wherein all carboxylic acid groups are separated by at least two carbon atoms and all hydroxyl groups are separated by at least two carbon atoms. The acid alcohols are linked to one another by linking groups comprising two or more carbon atoms. In one embodiment the linking groups comprise 2 to 12 carbon atoms and preferably 2 to 10 carbon atoms. In various other embodiments the linking group comprises 2 to 4, 2 to 3, and 2 carbon atoms. Linking groups may include one or more heteroatoms such as tertiary nitrogen, oxygen or sulfur. The linking group can optionally be substituted with amide, ester, or ether functionality as disclosed above for polyacids. The amino alcohol may comprise an amine and hydroxyl terminated polyamide, polyester or polyether.

Preferably the acid alcohol has an equivalent weight of 38 to less than 2000, and more preferably 38 to 1000, 38 to 500, or 38 to 300. The equivalent weight of the acid alcohol is determined by calculation or if the acid alcohol is an oligomer or polymer, by titration using ASTM 974 for determination of acid number and ASTM E 1899-08 method for hydroxyl number determination. The acid alcohol equivalent weight includes carboxylic acid and hydroxyl groups as determined by dividing the mass by the total number of acid and hydroxyl groups.

Acid alcohols include aliphatic acid alcohols, aromatic acid alcohols, monoacid mono-alcohols, monoacid polyols, diacid mono-alcohols, diacid polyols, triacid mono-alcohols, triacid polyols, tetra-acid mono-alcohols, tetra-acid polyols, and low molecular weight acid polyols.

Specific aliphatic acid alcohols useful in the invention include: glycolic acid, lactic acid, 2-hydroxyisobutyric acid, 3-hydroxybutyric acid, 2-hydroxy-2-methylbutyric acid, 2-ethyl-2-hydroxybutyric acid, 2-hydroxy-3-methylbutyric acid, 2-hydroxyisocapric acid, 2-hydroxycaproic acid, 10-hydroxydecanoic acid, 12-hydroxydodecanoic acid, 16-hydroxyhexadecanoic acid, 12-hydroxystearic acid, 2,2-bis(hydroxymethyl)propionic acid, gluconic acid, malic acid, citramalic acid, 2-isopropylmalic acid, 3-hydroxy-3-methylglutaric acid, tartaric acid, mucic acid, citric acid, quinic acid, shikimic acid, alginic acid.

Specific aromatic acid alcohols useful in the invention include: benzilic acid, 3-phenyllactic acid, tropic acid, 2-hydroxyphenylacetic acid, 3-(2-hydroxyphenyl)propionic acid, 4-hydroxyphenylacetic acid, 4,4-bis(4-hydroxyphenyl)valeric acid, homovanilic acid, 3,4-dihydroxymandelic acid, 2,5-dihydroxyphenylacetic acid, 3,4-dihydroxyhydrocinnamic acid, 3-hydroxybenzoic acid, 4-hydroxybenzoic acid, 4-(hydroxymethyl)benzoic acid, 2,3-dihydroxybenzoic acid, 2,6-dihydroxybenzoic acid, 3,4-dihydroxybenzoic acid, 2,5-dihydroxybenzoic acid, 2,4-dihydroxybenzoic acid, 4-hydroxyisophtalic acid, 5-hydroxyisophtalic acid, 2,4,6-trihydroxybenzoic acid, gallic acid, 1,4-dihydroxy-2-naphtoic acid, 3,5-dihydroxy-2-naphtoic acid, 3,7-dihydroxy-2-naphtoic acid.

Melt-blending of the polyepoxy compound and the carboxylic acid compounds in the presence of polyamide resin melt provides the conditions for the polyepoxy compound and the carboxylic acid compound to react such that one or more carboxylic acid functionality or hydroxyl functionality, if present, reacts with one or more epoxy group of the polyepoxy compound to form an ester (C—O—C(O)—C) linkage and/or ether linkage (C—O—C) via ring-opening of the epoxy functionality. The ring-opening reaction also provides an equivalent of hydroxyl group for each polyester link and/or polyether link formed. Herein, the reaction product is referred to as “polyacid-polyol compound.” The reacting also may be accomplished in the absence of polyamide resin by mixing and heating a combination of polyepoxy and carboxylic acid compound to a reaction temperature for a reaction period to provide a percent conversion of the polyepoxy. The percent epoxy conversion of the polyepoxy compound may be determined in the absence of polyamide resin by measuring the ¹H NMR signal of one of the epoxy ring hydrogen diastereomers versus a second internal standard signal that does not change during the reaction. Thus, the reaction of selected polyepoxy and carboxylic acid compound in the absence of polyamide resin can be used to empirically determine the propensity for a selected polyepoxy/carboxylic acid compound composition to gel. Gelling, that is, cross-linking, is undesirable as the viscosity of the composition increases rapidly to the point where the composition may not be processible.

In a preferred embodiment the thermoplastic melt-mixed composition has a ratio of c) to b) such that, in the absence of other components, c) and b) can react to provide at least 10 percent conversion of epoxy equivalents of component (b) up to, but excluding, the gel point of the components b) and c).

Suitable reaction temperatures in the absence of polyamide resin include the range of 23° C. to 250° C. Suitable reaction periods include the range of 1 minute to about 24 hours. As desired by the artisan, the reaction may be performed: under a range of pressure, for instance 2 atmospheres to about 0.01 mm Hg; in the presence or absence of a catalysis, e.g. acid catalysis or base catalysis; and in the presence or absence of a solvent; in the presence or absence of a plasticizer, or other additive that may be ultimately found desirable in the thermoplastic melt-mixed composition. In one embodiment the reaction is performed in the absence of a catalyst.

Reacting the combination of the polyepoxy compound (b) and the carboxylic acid compound (c) provides a reaction product having a range of at least 10 percent conversion of epoxy equivalents of component (b) up to, but excluding, the gel point of the components b) and c). In various embodiments the reaction product has preferred ranges of at least 25 percent conversion, 40 percent conversion, 50 percent conversion, 80 percent conversion and 85 percent conversion, of epoxy equivalents of component (b) up to, but excluding, the gel point of the components b) and c).

Various embodiments include many combinations of polyepoxy compound (b) and carboxylic acid compound (c) that provide a reaction product that can be taken to 100% epoxy conversion without reaching the gel point.

The upper limit of the extent of reaction of polyepoxy compound (b) and carboxylic acid compound (c) to provide a useful reaction product is just below the gel point. The gel point is the point wherein the material is crosslinked and can no longer flow and be melt-blended to provide a uniform blend. The gel point can be calculated using a modified Carothers equation (G. Odian, Principles of Polymerization, 1981, ISBN 0-471-05146-2, John Whey & Sons, Inc., p. 117-119) which is a statistical equation for nonequivalent (nonstoichiometric) reactant mixtures for 2 reagents, having at least 2 reactive groups A and B per molecule and at least one having more than 2 groups per molecule:

pc=1/{r[1+(fA−2)][1+(fB−2)]}exp 1/2 Eq. (I)

where:
pc=conversion of group A at gel point, conversion of group B is r×pc
r=1 or <1, ratio of A to B groups
f>2 is a functionality of the reagent with functionality >2.

Examples of gel points (G-1-G-6), calculated using Eq (I) for various combinations of reagent functionality are listed in Table 1.

TABLE 1

| Gel point examples | G1 | G2 | G3 | G4 | G5 | G6 |
|---|---|---|---|---|---|---|
| Reagent A (polyepoxy) | 4 | 4 | 6 | 6 | 4 | 6 |
| functionality (fA) | | | | | | |
| Reagent B (carboxylic acid) | 2 | 2 | 2 | 2 | 4 | 6 |
| functionality (fB) | | | | | | |
| Molar ratio of A to B reagents | 0.5 | 0.25 | 0.33 | 0.083 | 1 | 0.5 |
| Molar (or equivalent) ratio of | 1 | 0.5 | 1 | 0.5 | 1 | 0.5 |
| A to B groups (r) | | | | | | |
| Gel Point (pc for conversion | 0.577 | 0.816 | 0.447 | 0.894 | 0.333 | 0.283 |
| of group A, from Eq. 1) | | | | | | |

In a preferred embodiment the ratio of c) carboxylic acid compound to b) polyepoxy compound is such that the ratio of carboxylic acid and hydroxyl groups to epoxy group is in the range of 0.1 to 200, and more preferably 1.1 to 200 (excess carboxyl and hydroxyl). Other embodiments include ratios of carboxylic acid and hydroxyl groups to epoxy group of 1.1 to 50, 1.1 to 10, 1.5 to 10 and 1.5 to 5. The ratio is determined by dividing the amount of each reagent used by the equivalent weight of the polyepoxy compound and the carboxylic acid compound, respectively.

### Reinforcing Agent

The thermoplastic melt-mixed composition comprises 10 to about 60 weight percent, and preferably 12.5 to 55, and 15 to 50 weight percent, of one or more reinforcement agents. The reinforcement agent may be any filler, but is preferably selected from the group consisting calcium carbonate, glass fibers with circular and noncircular cross-section, glass flakes, glass beads, carbon fibers, talc, mica, wollastonite, calcined clay, kaolin, diatomite, magnesium sulfate, magnesium silicate, barium sulfate, titanium dioxide, sodium aluminum carbonate, barium ferrite, potassium titanate and mixtures thereof. In preferred embodiments the reinforcing agent is selected from the group consisting of glass fiber having a circular cross section and glass fiber with noncircular cross-section. The glass fiber may have sizing or coupling agents, organic or inorganic materials that improve the bonding between glass and the polyimide resin.

Glass fibers with noncircular cross-section refer to glass fiber having a cross section having a major axis lying perpendicular to a longitudinal direction of the glass fiber and corresponding to the longest linear distance in the cross section. The non-circular cross section has a minor axis corresponding to the longest linear distance in the cross section in a direction perpendicular to the major axis. The non-circular cross section of the fiber may have a variety of shapes including a cocoon-type (figure-eight) shape, a rectangular shape; an elliptical shape; a roughly triangular shape; a polygonal shape; and an oblong shape. As will be understood by those skilled in the art, the cross section may have other shapes. The ratio of the length of the major axis to that of the minor access is preferably between about 1.5:1 and about 6:1. The ratio is more preferably between about 2:1 and 5:1 and yet more preferably between about 3:1 to about 4:1. Suitable glass fiber are disclosed in EP 0 190 001 and EP 0 196 194.

### Polymeric Toughener

The thermoplastic melt-mixed composition, optionally, comprises 0 to 30 weight percent of a polymeric toughener comprising a reactive functional group and/or a metal salt of a carboxylic acid. In one embodiment the composition comprises 2 to 20 weight percent polymeric toughener selected from the group consisting of: a copolymer of ethylene, glycidyl (meth)acrylate, and optionally one or more (meth)acrylate esters; an ethylene/α-olefin or ethylene/α-olefin/diene copolymer grafted with an unsaturated carboxylic anhydride; a copolymer of ethylene, 2-isocyanatoethyl (meth)acrylate, and optionally one or more (meth)acrylate esters; and a copolymer of ethylene and acrylic acid reacted with a Zn, Li, Mg or Mn compound to form the corresponding ionomer.

The thermoplastic composition of the present invention may also comprise 0 to 10 weight percent further additives such as further heat stabilizers or antioxidants referred to as “co-stabilizers” other than polyepoxy compound and carboxylic acid compounds disclosed herein, antistatic agents, blowing agents, plasticizers, lubricants and colorant and pigments. In one embodiment 0.02 to 0.5 weight percent of one or more lubricants is present. In another embodiment 0.1 to 3.0 weight percent of one or more colorants is present; wherein the weight percent colorant includes the weight of the carrier accompanying the colorant. In one embodiment the colorant is selected from the group of carbon black and nigrosine black pigment.

Co-stabilizers include copper stabilizers, secondary aryl amines, hindered amine light stabilizers (HALS), hindered phenols, and mixtures thereof, that are disclosed in US patent application publication 2010/0029819, Palmer et al, herein incorporated by reference.

In one embodiment further additives should not include inorganic bases selected from metal oxides and metal hydroxides. For instance, presence of magnesium hydroxide in the thermoplastic melt-mixed composition having polyepoxy compound and carboxylic acid compound was found to have significant negative effect on the AOA tensile strength retention.

Another embodiment is the thermoplastic melt-mixed composition wherein further additives are present selected from the group consisting of amino compounds selected from the group consisting polyamines, amino alcohols and combinations of these; amino acids; polyhydric alcohols; and combinations of these.

Useful amino compounds are selected from the group consisting polyamines, amino alcohols and combinations of these, having a number average molecular weight (Mₙ) of up to 3,000,000, and preferably up to 1,000,000, 500,000, 100,000, 50,000, 40,000, 20,000, 10,000, 1000, or 500; with the proviso that the amino compounds do not comprise a secondary aryl amine or a nonaromatic site of carbon-carbon unsaturation, e.g., carbon-carbon double bonds.

The amino compounds include polyamines comprising two or more amines, and said two or more amines are selected from the group consisting of primary aliphatic amines, primary aromatic amines, secondary aliphatic amines and combinations of these. Preferably the polyamine has an equivalent weight of 30 to 2000, and more preferably 30 to 1000, 30 to 500, or to 200. The equivalent weight of the polyamine is determined by calculation or if the polyamine is an oligomer or polymer, by titration using ASTM D2074 D-9-J method.

The amino compounds include amino alcohols having one or more amines and one or more hydroxyl groups, wherein the at least one amine is selected from the group consisting of primary aliphatic amine, primary aromatic amine, secondary aliphatic amine and combinations of these. Preferably the amino alcohol has an equivalent weight of 30 to 2000, and more preferably 30 to 1000, 30 to 500, or 30 to 200. The equivalent weight of the amino alcohol is determined by calculation or if the amino alcohol is an oligomer or polymer, by titration using ASTM D2074 D-9-J method. The amino alcohol equivalent weight includes amine and hydroxyl groups and is determined by dividing the mass by the total number of amine and hydroxyl groups.

When present, preferably the amino compound is present at 0.5-4.0 weight percent, 0.5 to 2.0 weight percent and 0.5 to 1.5 weight percent, in the thermoplastic melt-mixed composition.

The term amino compound includes salts of amino compound, for example, polyphosphate salts, hydrochloride salts, acetic acid salts, and cyanurate salts.

The amino groups and hydroxyl groups are linked to one another by linking groups comprising two or more carbon atoms. In one embodiment the linking groups comprise 2 to 6 carbon atoms. In various other embodiments the linking group comprises 2 to 4, 2 to 3, and 2 carbon atoms. Linking groups may include one or more heteroatoms such as tertiary nitrogen, oxygen or sulfur. The linking group can optionally be substituted with amide, ester, or ether functionality. For instance, the polyamine may comprise a polyamide oligomer having amine ends; or a polyether having amine ends, for example amine capped polyethylene glycol). In various embodiments the polyamine is selected from the group consisting of a polyamide oligomer, polyether oligomer or polyester oligomer, said oligomer having a number average molecular weight less than 4000, as determined with SEC. Likewise the amino alcohol may comprise an amine and hydroxyl terminated polyamide, polyester or polyether.

The amino compound does not comprise a functional group selected from the group consisting of a secondary aryl amine; carboxylic acid; and nonaromatic sites of carbon-carbon unsaturation. The term “amino compounds” does not encompass compounds that have tertiary amines as the only amino functional group.

Specific polyamines families include those selected from the group consisting of aliphatic polyamines, aromatic polyamines, arylalkyl polyamines, and high molecular weight polymeric polyamines, and combinations of these.

Alipahtic polyamines include those selected from the group consisting of ethylene diamine, diethylene triamine, triethylene tetramine, hexamethylene diamine.

Aromatic polyamines include those selected from the group consisting of melamine, melamine polyphosphate, 6-phenyl-1,3,5-triazine-2,4-diamine, melamine cyanurate, and combinations of these. A preferred aromatic amine is melamine.

High molecular weight polymeric polyamines include those selected from the group consisting of polyethyleneimines homopolymers and copolymers disclosed in US 2008/0262133 A1, herein incorporated by reference, and commercially available from BASE; and poly(4-amino styrene) (MW>150,000) and poly(N-methylvinylamine) (MW=500,000), commercially available from Polysciences, Inc; and the polyetheramines available under the tradename Jeffamine® resins available from Huntsman Chemical, Houston, Tex.

Specific amino alcohol families include those selected from the group consisting of aliphatic amino alcohols, aromatic amino alcohols, arylalkyl polyamines, and high molecular weight polymeric amino alcohols, and combinations of these.

Specific amino alcohols useful in the invention include ethanolamine 2-(methylamino)ethanol, 3-amino-1-propanol, amino-2-propanol, 2-amino-1,-propanol, (±)-3-amino-1,2-propanediol, 2-amino-1,3-propanediol, 1,3-diamino-2-propanol, 2-(ethylamino)ethanol, 2-amino-1-butanol, 2-amino-2-methyl-1-propanol, 4-amino-1-butanol, 2-(2-aminoethoxy)ethanol, 3-methylamino-1,2-propanediol, diethanolamine, tris(hydroxymethyl)aminomethane, N-(2-hydroxyethyl)ethylenediamine, 2-(isopropylamino)ethanol, 2-(propylamino)ethanol, 2-amino-3-methyl-1-butanol, 5-amino-1-pentanol, DL-2-amino-1-pentanol, 2-(3-aminopropylamino)ethanol, 1-amino-1-cyclopentanemethanol, 2-(butylamino)ethanol, 2-(tert-butylamino)ethanol, 6-amino-1-hexanol, DL-2-amino-1-hexanol, bis(2-hydroxypropyl)amine, N,N′-bis(2-hydroxyethyl)ethylenediamine, 2-aminobenzyl alcohol, 3-aminobenzyl alcohol, 4-aminobenzyl alcohol, 2-amino-4-methoxyphenol, 5-amino-2,2-dimethylpentanol, 2-amino-1-phenylethanol, 2-amino-3-methylbenzyl alcohol, 2-amino-5-methylbenzyl alcohol, 2-aminophenethyl alcohol, 3-amino-2-methylbenzyl alcohol, 3-amino-4-methylbenzyl alcohol, 4-(1-hydroxyethyl)aniline, 4-aminophenethyl alcohol, N-(2-hydroxyethyl)aniline, 2-benzylaminoethanol, α-(methylaminomethyl)benzyl alcohol, α-[2-(methylamino)ethyl]benzyl alcohol, 3-amino-1-adamantanol; and 1,3-bis[tris(hydroxymethyl)methylamino]propane.

Useful amino acids are selected from the group consisting of primary amino acids and secondary amino acids; said amino acid having no hydroxyl groups and no more than one carboxylic acid. Preferably the amino acid has a number average molecular weight of less than or equal to about 1000, preferably less than 500 or 300, as determined by calculation of molecular weight of the amino acid thermal stabilizer; or, if the amino acid is an oligomeric material, as determined with size exclusion chromatography. Amino acids useful in the invention include aliphatic amino acids and aromatic amino acids. In one embodiment the amino acid is a primary amino acid.

The term “amino acid” includes salts and hydrates of amino acids including hydrochlorides, acetates, phosphates, monohydrates, and sodium and potassium salts.

Aliphatic amino acids include those selected from the group consisting of: N-methylglycine, DL-alanine, aminocyclohexanepropionic acid, 2-aminoisobutyric acid, 2-aminobutyric acid, DL-valine, DL-tert-leucine, DL-norvaline, DL-isoleucine, DL-leucine, DL-norleucine, DL-2-aminocaprylic acid, beta-alanine, DL-3-aminoisobutyric acid, DL-3-aminobutyric acid, 4-aminobutyric acid, 5-aminovaleric acid, 6-aminocaproic acid, 7-aminoheptanoic acids, 8-aminocaprylic acid, 11-aminoundecanoic acid, 12-aminododecanoic acid, 1-amino-1-cyclopropanecarboxylic acid, 1-amino-1-cyclopentanecarboxylic acid, 1-amino-1-cyclohexanecarboxylic acid, trans-4-(aminomethyl)-cyclohexanecarboxylic acid, 2-amino-2-norbornanecarboxylic acid, DL-proline, DI-dipecanolic acid, nipecotic acid, and DL-lysine.

Aromatic amino acids include those selected from the group consisting of: -aminobenzoic acid, 3-aminobenzoic acid, 2-aminobenzoic acid, 2-phenylglycine, 2,2-diphenylglycine, N-phenylglycine, DL-phenylalanine, alpha-methyl-DL-phenylalanine, DL-homophenylalanine, DL-2-fluorophenylglycine, DL-2-fluorphenylalanine, 4-amino-DL-phenylalanine hydrate, and N-tritylglycine,

In one embodiment the amino acid is selected from the group consisting of 6-aminohexanoic acid, lysine, 11-aminoundecanoic acid, 4-aminobenzoic acid; and salts of these compounds.

Useful polyhydric alcohols have two or more hydroxyl groups and a have a hydroxyl equivalent weight of 30 to 1000 g/equivalent, and preferably 80 to 500 g/equivalent, as determined by calculation, or if an oligomer is used, by hydroxyl number determination according to ASTM E 1899-08.

Polyhydric alcohols include those selected from the group consisting of polyhydroxy polymers having a number average molecular weight (Mₙ) of more than 2000, as determined with size exclusion chromatography (SEC) and polyhydric alcohols having a Mₙ of less than 2000 by molecular weight calculation or, for oligomeric polyhydric alcohols, as determined with (SEC).

Polyhydroxy polymers include those selected from the group consisting of ethylene/vinyl alcohol copolymers and poly(vinyl alcohol). Preferably the polyhydroxy polymer has a Mₙ of 5,000 to 50,000. In one embodiment the polyhydroxy polymer is an ethylene/vinyl alcohol copolymer (EVOH). The EVOH may have a vinyl alcohol repeat content of 10 to 90 mol % and preferably 30 to 80 mol %, 40 to 75 mol %, 50 to 75 mol %, and 50 to 60 mol %, wherein the remainder mol % is ethylene. A suitable EVOH for the thermoplastic composition is Soarnol® A or D copolymer available from Nippon Gosei (Tokyo, Japan) and EVAL® copolymers available from Kuraray, Tokyo, Japan.

In one embodiment the polyhydroxy polymer is a polyvinyl alcohol) polymer (PVOH). Suitable PVOH polymers for the thermoplastic composition are the Mowiol® brand resins available from Kuraray Europe Gmbh.

Polyhydric alcohols having a number average molecular weight (Mₙ) of less than 2000, include aliphatic hydroxylic compounds containing more than two hydroxyl groups, aliphatic-cycloaliphatic compounds containing more than two hydroxyl groups, cycloaliphatic compounds containing more than two hydroxyl groups, and saccharides and polysaccharides. Preferably the polyhydric alcohol has three or more hydroxyl groups. In a preferred embodiment the polyhydric alcohol has three to six hydroxyl groups.

An aliphatic chain in the polyhydric alcohol can include not only carbon atoms but also one or more hetero atoms which may be selected, for example, from nitrogen, oxygen and sulphur atoms. A cycloaliphatic ring present in the polyhydric alcohol can be monocyclic or part of a bicyclic or polycyclic ring system and may be carbocyclic or heterocyclic. A heterocyclic ring present in the polyhydric alcohol can be monocyclic or part of a bicyclic or polycyclic ring system and may include one or more hetero atoms which may be selected, for example, from nitrogen, oxygen and sulphur atoms. The one or more polyhydric alcohols may contain one or more substituents, such as ether, carboxylic acid, carboxylic acid amide or carboxylic acid ester groups.

Examples of polyhydric alcohol containing more than two hydroxyl groups include, without limitation, triols, such as glycerol, trimethylolpropane, 2,3-di-(2′-hydroxyethyl)-cyclohexan-1-ol, hexane-1,2,6-triol, 1,1,1-tris-(hydroxymethyl)ethane, 3-(2′-hydroxyethoxy)-propane-1,2-diol, 3-(2′-hydroxypropoxy)-propane-1,2-diol, 2-(2′-hydroxyethoxy)-hexane-1,2-diol, 6-(2′-hydroxypropoxy)-hexane-1,2-diol, 1,1,1-tris-[(2′-hydroxyethoxy)-methyl]-ethane, 1,1,1-tris-[(2′-hydroxypropoxy)-methyl]-propane, 1,1,1-tris-(4′-hydroxyphenyl)-ethane, 1,1,1-tris-(hydroxyphenyl)-propane, 1,1,3-tris-(dihydroxy-3-methylphenyl)-propane, 1,1,4-tris-(dihydroxyphenyl)-butane, 1,1,5-tris-(hydroxyphenyl)-3-methylpentane, trimethylolpropane ethoxylates, or trimethylolpropane propoxylates; polyols such as pentaerythritol, dipentaerythritol, di-trimethylolpropane, and tripentaerythritol; oligomers including diglycerol, triglycerol, tetraglycerol, pentaglycerol, hexaglycerol, heptaglycerol, octaglycerol, nonaglycerol, decaglycerol; and saccharides, such as cyclodextrin, D-mannose, glucose, galactose, sucrose, fructose, xylose, arabinose, D-mannitol, D-sorbitol, D- or L-arabitol, xylitol, iditol, talitol, allitol, altritol, guilitol, erythritol, threitol, and D-guionic-y-lactone; and the like.

Preferred polyhydric alcohols include those having a pair of hydroxyl groups which are attached to respective carbon atoms which are separated one from another by at least one atom. In one embodiment the polyhydric alcohol does not include an amine functionality in the form of primary, secondary or tertiary amine. Especially preferred polyhydric alcohols are those in which a pair of hydroxyl groups is attached to respective carbon atoms which are separated one from another by a single carbon atom.

Preferably, the polyhydric alcohol used in providing the polyetherol is selected from the group of glycerol (GLY), pentaerythritol (PE), dipentaerythritol (DPE), tripentaerythritol (TPE), di-trimethylolpropane (DTP), trimethylolpropane(TMP), 1,1,1-tris(hydroxymethyl) propane (THE) and mixtures of these.

Another embodiment is a thermoplastic melt-mixed composition as disclosed herein wherein the semi-crystalline polyamide resin is poly(hexamethylene hexanediamide/hexamethylene terephthalamide) (PA66/6T); the reinforcing agent is selected from the group consisting of glass fiber and glass fiber with noncircular cross-section, and mixtures of these; the one or more polyepoxy compound(s) is trimethylolpropane triglycidyl ether (TTE) and is present at 1.0 to 3.0 weight percent; and wherein the polyacid is selected from the group consisting of decanedioic acid and dodecanedioic acid (DDDA) and present at 0.5 to 2.0 weight percent; and the weight ratio of trimethylolpropane triglycidyl ether to polyacid is 0.5:1 to 3:1, and preferably 1:1 to 3:1.

Another embodiment is a thermoplastic melt-mixed composition comprising:
a) 15 to 89.5 weight percent of poly(hexamethylene hexanediamide);
b) 0.50 to 5.0 weight percent, and preferably 0.5 to 4.0, 1.0 to 4.0 and 1.0 to 3.0 weight percent of one or more polyepoxy compound(s) comprising at least 2 to 5 and preferably 2 to 4.5, 2 to 4 epoxy groups, on average, per molecule; the polyepoxy compound having an epoxide equivalent weight of 210-1200 and preferably 300-1200, 300-800 and 600-700 g/equivalent, as determined by calculation, or if the polyepoxy compound is an oligomer, by titration using ASTM D1652-11 method; and a number average molecular weight of less than 8000;
c) about 0.25 to 5.0 weight percent and preferably 0.5 to 4.0, 1.0 to 4.0, 1.0 to 3.0 and 1.0 to 2.0 weight percent of one or more carboxylic acid compounds having melting points of less than 280° C. and preferably a melting point of less than 250° C., selected from the group consisting of polyacids, acid alcohols and combinations of these, the carboxylic acid compounds having a number average molecular weight of less than 2000;
d) 10 to 60 weight percent of reinforcing agent;
e) 0 to 30 weight percent polymeric toughener; and
f) 0 to 10 weight percent of further additives;
wherein the weight per cents of components a), b), c) d) and e) are based on the total weight of the thermoplastic melt-mixed composition and wherein 2 mm thick test bars, prepared from said melt-mixed composition and exposed at a test temperature of 230° C. for a test period of 1000 hours, in an atmosphere of air, and tested according to ISO 527-2/1BA, have on average, a retention of tensile strength of at least 30 percent and preferably at least 40, 50, 60, or 70%, as compared with that of an unexposed control of identical composition and shape.

### Melt Blending

Herein the thermoplastic composition is a mixture by melt-blending, in which all polymeric ingredients are adequately mixed, and all non-polymeric ingredients are adequately dispersed in a polymer matrix. Any melt-blending method may be used for mixing polymeric ingredients and non-polymeric ingredients of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing filler presents a long physical shape (for example, a long glass fiber), drawing extrusion molding may be used to prepare a reinforced composition.

Another embodiment is a sequential process for providing a thermoplastic melt-mixed composition comprising:

A) melt-blending:
a) 15 to 89.5 weight percent semicrystalline polyamide resin having a melting point;
c) about 0.25 to 5.0 weight percent of one or more carboxylic acid compounds selected from the group consisting of polyacids, acid alcohols and combinations of these, the carboxylic acid compounds have a number average molecular weight of less than 2000;
d) 10 to 60 weight percent of reinforcing agent;
e) 0 to 30 weight percent polymeric toughener; and
f) 0-10 weight percent of further additives; to provide a polyamide-polyacid blend; and

B) melt-blending said polyamide-polyacid blend with
b) 0.5 to 5.0 weight percent of one or more polyepoxy compound comprising at least two or more epoxy groups; the polyepoxy compound having a epoxide equivalent weight of 43 to 4000 g/equivalent as determined by calculation, or if the polyepoxy compound is an oligomer, by titration using ASTM D1652-11 method; and a number average molecular weight (Mₙ) of less than 8000;
   wherein the weight percents of components a), b), c), d) e) and f) are based on the total weight of the thermoplastic melt-mixed composition.

In various embodiments of the melt-blend processes disclosed above:

component b) may be 0.5 to 4.0, 1.0 to 4.0 and 1.0 to 3.0 weight percent of one or more polyepoxy compound(s) comprising at least 2 to 5 and preferably 2 to 4.5, 2 to 4 epoxy groups, on average, per molecule, the polyepoxy compound having an epoxide equivalent weight of preferably 43 to 1000, 70 to 1000, 70 to 500, 70 to 200, 70 to 190 and 70 to 180 g/equivalent; and

component c) may be 0.5 to 4.0, 1.0 to 4.0, 1.0 to 3.0 and 1.0 to 2.0 weight percent of one or more carboxylic acid compounds having melting points of less than 280° C., and preferably a melting point of less than 250° C.

In one embodiment of the sequential process one or more of components d), e) and f) are melt-blended with said polyamide-polyacid blend in step B).

Another embodiment of the sequential process is wherein melt-blending said polyamide-polyacid blend with component b) is provided by metering in said one or more polyepoxy compound by pump into said polyamide-polyacid blend.

Another embodiment is a sequential process as disclosed above wherein the thermoplastic melt-mixed composition has a melt viscosity at a hold time of 25 minutes less than 600% (preferably less than 300, 200, and 130%) of the melt viscosity at a hold time of 5 minutes; as measured at temperature 10° C. to 30° C. above the melting point of the polyamide resin, in a capillary rheometer at a shear rate of 1000 sec⁻¹ according to ASTM D3835.

Another embodiment is a process for providing a thermoplastic melt-mixed composition comprising:

A) melt-blending:
a) 15 to 89.5 weight percent semicrystalline polyamide resin having a melting point;
b) 0.25 to about 5.0 weight percent of one or more polyepoxy compound comprising at least two or more epoxy groups; the polyepoxy compound having a epoxide equivalent weight of 43 to 4000 g/equivalent as determined by calculation, or if the polyepoxy compound is an oligomer, by titration using ASTM D1652-11 method; and a number average molecular weight (Mₙ) of less than 8000;
c) about 0.25 to 5.0 weight percent of one or more carboxylic acid compounds selected from the group consisting of polyacids, acid alcohols and combinations of these, the carboxylic acid compounds have a number average molecular weight of less than 2000;
d) 0 to 60 weight percent of reinforcing agent;
e) 0 to 30 weight percent polymeric toughener; and
f) 0-10 weight percent of further additives;

wherein components b) polyepoxy compound and c) carboxylic acid compounds are added simultaneously during the melt-blending.

Another embodiment is the simultaneous process disclosed above wherein the thermoplastic melt-mixed composition has a melt viscosity at a hold time of 25 minutes less than 600% of the melt viscosity at a hold time of 5 minutes; as measured at temperature 10° C. to 30° C. above the melting point of the polyamide resin, in a capillary rheometer at a shear rate of 1000 sec according to ASTM D3835.

Other embodiments of the process include 10 to 60 weight percent of component d) reinforcing agent, with the requisite reduction in the amount of polyamide to 15 to 89 weight percent.

All preferred embodiments disclosed above for the thermoplastic melt-mixed compositions are applicable to the processes and methods for preparing the thermoplastic melt-mixed compositions disclosed herein.

In preferred embodiments the thermoplastic melt-mixed compositions disclosed above have a melt viscosity at a hold time of 25 minutes less than 600% and preferably less than 300, 200, and most preferably, less than 130%, of the melt viscosity at a hold time of 5 minutes; as measured at temperature 10° C. to 30° C. above the melting point of the polyamide resin, in a capillary rheometer at a shear rate of 1000 seq⁻¹ according to ASTM D3835.

The melt-mixed compositions, as disclosed above, are useful in increasing long-term thermal stability at high temperatures of molded or extruded articles made therefrom. The long-term heat stability of the articles can be assessed by exposure (air oven aging) of 2 mm thick test samples at various test temperatures in an oven for various test periods of time. The oven test temperatures for the compositions disclosed herein may be 170° C. and 500, 1000, or 2000 hours test periods; 210° C. and 500 or 1000 hours test periods; and 230° C. and 500, 1000 or 1500 hours test periods. The test samples, after air oven aging, are tested for tensile strength and elongation to break, according to ISO 527-2/1BA test method; and compared with unexposed controls having identical composition and shape, that are dry as molded (DAM). The comparison with the DAM controls provides the retention of tensile strength and/or retention of elongation to break, and thus the various compositions can be assessed as to long-term heat stability performance.

Another embodiment is a method for improving tensile strength retention of a thermoplastic melt-mixed composition under air oven aging (AOA) conditions comprising:

melt-blending:
a) 15 to 89.5 weight percent of a semicrystalline polyamide resin having a melting point;
b) 0.25 to about 5.0 weight percent of one or more polyepoxy compound comprising at least two or more epoxy groups; the polyepoxy compound having a epoxide equivalent weight of 43 to 4000 g/equivalent as determined by calculation, or if the polyepoxy compound is an oligomer, by titration using ASTM D1652-11 method; and a number average molecular weight (Mₙ) of less than 8000;
c) about 0.25 to 5.0 weight percent of one or more carboxylic acid compounds selected from the group consisting of polyacids, acid alcohols and combinations of these, the carboxylic acid compounds have a number average molecular weight of less than 2000;
d) 10 to 60 weight percent of reinforcing agent;
e) 0 to 30 weight percent polymeric toughener;
f) 0 to 10 weight percent of further additives;
   wherein the polyepoxy compound and carboxylic acid compound react to provide said thermoplastic melt-mixed composition; wherein 2 mm thick test bars, prepared from said melt-mixed composition and tested according to ISO 527-2/1BA, and exposed at a test temperature of 230° C. for a test period of 1000 hours, in an atmosphere of air, have on average, a retention of tensile strength of at least 30 percent, and preferably at least 40, 50, 60, 70, or 80 percent, as compared with that of an unexposed control of identical composition and shape; and wherein the polyamide resin comprises a one or more polyamides selected from the group consisting of Group (IIB) Polyamides, Group (III) Polyamides, Group (IV) Polyamides, Group (V) Polyamides as defined herein.

In various embodiments of the method for improving tensile strength disclosed above:

component b) may be 0.5 to 4.0, 1.0 to 4.0 and 1.0 to 3.0 weight percent of one or more polyepoxy compound(s) comprising at least 2 to 5 and preferably 2 to 4.5, 2 to 4 epoxy groups, on average, per molecule, the polyepoxy compound having an epoxide equivalent weight of preferably 43 to 1000, 70 to 1000, 70 to 500, 70 to 200, 70 to 190 and 70 to 180 g/equivalent; and

component c) may be 0.5 to 4.0, 1.0 to 4.0, 1.0 to 3.0 and 1.0 to 2.0 weight percent of one or more carboxylic acid compounds having melting points of less than 280° C., and preferably a melting point of less than 250° C.

One embodiment is a molded or extruded thermoplastic article comprising the thermoplastic melt-mixed composition as disclosed in the above, wherein the polyamide resin comprises one or more Group (I) Polyamides, wherein 2 mm thick test bars, prepared from said melt-mixed composition and tested according to ISO 527-2/1BA, and exposed at a test temperature of 170° C. for a test period of 500 hours, in an atmosphere of air, have on average, a retention of tensile strength of at least 30 percent, and preferably at least 50, 60, 70, 80, and 90%, as compared with that of an unexposed control of identical composition and shape.

One embodiment is a molded or extruded thermoplastic article comprising the thermoplastic melt-mixed composition, as disclosed in the above embodiments, wherein the polyamide resin comprises one or more Group (II) Polyamides, wherein 2 mm thick test bars, prepared from said melt-mixed composition and tested according to ISO 527-2/1BA, and exposed at a test temperature of 210° C. for a test period of 500 hours, in an atmosphere of air, have on average, a retention of tensile strength of at least 30 percent, and preferably at least 40, 50, 60, 70, 80, and 90%, as compared with that of an unexposed control of identical composition and shape.

One embodiment is a molded or extruded thermoplastic article comprising the thermoplastic melt-mixed composition, as disclosed in the above embodiments, wherein the polyamide resin comprises a one or more polyamides selected from the group consisting of Group (IIB) Polyamides, Group (III) Polyamides, Group (IV) Polyamides, Group (V) Polyamides, and Group (VI) Polyamides, wherein 2 mm thick test bars, prepared from said melt-mixed composition and tested according to ISO 527-2/1BA, and exposed at a test temperature of 230° C. for a test period of 1000 hours, in an atmosphere of air, have on average, a retention of tensile strength of at least 30 percent; and preferably at least 40, 50, 60, 70, 80, and 90%, as compared with that of an unexposed control of identical composition and shape.

In another aspect, the present invention relates to a method for manufacturing an article by shaping the thermoplastic polyamide composition disclosed herein. Examples of articles are films or laminates, automotive parts or engine parts or electrical/electronics parts. By “shaping”, it is meant any shaping technique, such as for example extrusion, injection molding, thermoform molding, compression molding or blow molding. Preferably, the article is shaped by injection molding or blow molding.

The molded or extruded thermoplastic articles disclosed herein may have application in many vehicular components that meet one or more of the following requirements: high impact requirements; significant weight reduction (over conventional metals, for instance); resistance to high temperature; resistance to oil environment; resistance to chemical agents such as coolants; and noise reduction allowing more compact and integrated design. Specific molded or extruded thermoplastic articles are selected from the group consisting of charge air coolers (CAC); cylinder head covers (CHC); oil pans; engine cooling systems, including thermostat and heater housings and coolant pumps; exhaust systems including mufflers and housings for catalytic converters; air intake manifolds (AIM); and timing chain belt front covers. As an illustrative example of desired mechanical resistance against long-term high temperature exposure, a charge air cooler can be mentioned. A charge air cooler is a part of the radiator of a vehicle that improves engine combustion efficiency. Charge air coolers reduce the charge air temperature and increase the density of the air after compression in the turbocharger thus allowing more air to enter into the cylinders to improve engine efficiency. Since the temperature of the incoming air can be more than 200° C. when it enters the charge air cooler, it is required that this part be made out of a composition maintaining good mechanical properties under high temperatures for an extended period of time. Also it is very desirable to have a shaped article that exhibits no whitening or very little whitening upon aging.

The present invention is further illustrated by the following examples. It should be understood that the following examples are for illustration purposes only, and are not used to limit the present invention thereto.

### Methods

### Compounding Methods

30 mm Extruder Method:

Examples and Comparative Examples in Tables 1-9, 10A, 10C, 12, 13, 15A, 19 and 20 were prepared by melt blending the ingredients listed in the Tables in a 30 mm twin screw extruder (ZSK 30 by Coperion) operating at about 280-290° C. for Polyamide B and PA66 compositions and 310° C. barrel setting for Polyamide A (PA 6T/66 55:45) compositions, using a screw speed of about 300-400 rpm, a throughput of 30-40 lb/h (13.6-18.1 kg/hour) and a melt temperature measured by hand of about 300-370° C. for all the compositions. The glass fibers were added to the melt through a screw side feeder, all other ingredients were added at the beginning of the extruder except as noted in Methods 1, 2 and 3 below. Ingredient quantities shown in the Tables are given in weight percent on the basis of the total weight of the thermoplastic composition.

The following methods were used to add the liquid polyepoxy compound:

Method 1 (used in Examples listed in Table 4, 7 and 8)—The polyepoxide was pre-mixed with the glass fiber, and shaken in a plastic bag, and the mixture was added into barrel 5 of the ZSK 30 extruder.

Method 2—The liquid polyepoxide TTE was metered by a Teledyne ISCO pump and added into barrel 4 of the ZSK 30 extruder just before the addition of glass fiber at barrel 5.

Method 3—A fraction (e.g. 500 g) of the polyamide was subjected to cryogenic grinding in a Bantam Micropulverizer to provide about 1 millimeter average particle size particles. The liquid or oil ingredients (for instance TTE), were blended into the ground particles to provide a uniform blend and the uniform blend added to the extruder.

The compounded mixture was extruded in the form of laces or strands, cooled in a water bath, chopped into granules.

### 40 mm Extruder Method:

Examples and Comparative Examples listed in Tables 10B, 11, 14A-14E, 15B, 16 and 17 were prepared similarly to the procedure disclosed above, with the exception that a 40 mm twin screw extruder (Werner & Pfleiderer ZSK-40) was used. Barrel temperatures were set at 280° C. with a screw speed of 200-500 rpm, and throughput of 175-350 lb/h (79.4-158.8 kg/hr), and melt temperatures were measured between 300° C. 370° C. for all compositions. The glass fibers were added to the melt through a screw side feeder and all other ingredients were added at the beginning of the extruder with the exception of TTE epoxide, which was added by Method 2 as disclosed above with the exception that a K-Tron pump was used.

### Mechanical Tensile Properties

Mechanical tensile properties, i.e. E-modulus, stress at break (Tensile strength) and strain at break (elongation at break) were measured according to ISO 527-2/1BA. Measurements were made on 2 mm thick injection molded ISO tensile bars at a testing speed of 5 mm/min. Mold temperature for PA 6T/DT test specimens was 145-150° C.; mold temperature for PA 6T/66 test specimens was 90-100° C.; and melt temperature was 325-330° C. for both resins.

### Air Oven Aging (AOA)

The test specimens were heat aged in a re-circulating air ovens (Heraeus type UT6060) according to the procedure detailed in ISO 2578. At various heat aging times, the test specimens were removed from the oven, allowed to cool to room temperature and sealed into aluminum lined bags until ready for testing. The tensile mechanical properties were then measured according to ISO 527 using a Zwick tensile instrument. The average values obtained from 5 specimens are given in the Tables.

### Melt Viscosity

Melt viscosity retention was determined at a hold time of 25 minutes as compared to the melt viscosity at a hold time of 5 minutes; as measured at temperature 10° C. to 30° C. above the melting point of the polyamide resin, in a capillary rheometer (Kayness) at a shear rate of 1000 sec⁻¹ according to ASTM D3835.

### ¹H NMR Method for Epoxy Conversion

The 1H spectra are recorded in CDCl₃ on Bruker 500 MHz NMR Spectrometer operating at 500 MHz. The percent conversion of the epoxy functionality in the polyepoxy compound is determined by measuring the ¹H NMR signal of one of the epoxy ring hydrogen diastereomers versus a second internal standard signal that does not change during the reaction with polyhydroxy compound. The ratio of the epoxy ring hydrogen signal to the standard signal, adjusted for the moles of epoxy functionality and standard in the starting composition, and number of hydrogens in the standard signal, is used to determine the % conversion. For instance, with trimethylolpropane triglycidyl ether (TTE), the methyl group of the TTE is chosen as the internal standard signal (0.80 ppm) and one of the epoxy hydrogen diastereomers (2.55 ppm) is the epoxy signal measured. The following calculation provides the % conversion:

$$Epoxy Conversion ( \% ) = 100 - \frac{\begin{matrix}Area peak at 2.55 ppm \\ ( broad \underline{CH 2} , TTE epoxy ring )\end{matrix}}{\begin{matrix}Area peak at 0.80 ppm \\ ( broad \underline{CH 3} CH 2 \text{-} , TTE )\end{matrix}} \times 100$$

In this case no adjustment of the ratio is needed as there are three equivalent epoxy groups each having one equivalent diastereomer hydrogen and three equivalent methyl hydrogens in the internal standard.

Whitening Determination Method

Two 5 in×3 in×3 mm plaques were treated by placing in an environmental chamber under conditions of 85% relative humidity and 85° C. After one day one plaque was removed from the chamber and visually inspected. The L value, determined at 110° reflection was measured with a ChromaVision MA100 Multi-Angle Spectrophotometer (manufactured by X-Rite, Incorporated, Grandville, Mich.). L is a common measure of whiteness on the CIELAB colorspace. The L value was measured at 4 places on the plaque, both front and back and the L values averaged. A determination of L also was performed on an untreated plaque. A ΔL value was determined by subtracting the average of the four L measurements of the untreated plaque from the average of the four measurements from the treated plaque. After 7 days, the second plaque was removed from the chamber and the L value and ΔL value determined.

Low L values correspond to darker plaques and higher L values correspond to lighter plaques. Therefore a positive ΔL means a change from darker to lighter.

A survey found that, by visual observation, those of ordinary skill in the art could identify three levels of whitening, listed in Table B, corresponding to the ΔL values determined by spectroscopic measurements means. Thus, using this relationship in some examples, visual observation was used to evaluate whitening where the L values could not be conveniently measured.

TABLE B
Characterization of Whitening

| Visual observation | ΔL (110°) |
|---|---|
| none | ΔL < 5 |
| slight | 5 < ΔL < 15 |
| moderate | 15 < ΔL < 25 |
| severe | ΔL > 25 |

### Materials

Polyamide. A refers Zytel® HTN502HNC010 6/66_copolyamide, made from terephthalic acid, adipic acid, and hexamethylenediamine; wherein the two acids are used in a 55:45 molar ratio (PA 6T166); having a melting point of about 310° C. and an inherent viscosity (IV), according to ASTM D2857 method, typically about 1.07, available from E.I. DuPont de Nemours and Company, Wilmington, Del., USA.

Polyamide B refers to PA6616T (75/25 molar ratio repeat units) with amine ends approximately 80 meq/kg, having a typical relative viscosity (R^{V}) of 41, according to ASTM 0-789 method, and a typical melt point of 268° C., that was provided according to the following procedure:

Polyamide 66 salt solution (3928 lbs. of a 51.7 percent by weight with a pH of 8.1) and 2926 lbs of a 25.2% by weight of polyimide 6T salt solution with a pH of 7.6 were charged into an autoclave with 100 g of a conventional antifoam agent, 20 g of sodium hypophosphite, 220 g of sodium bicarbonate, 2476 g of 80% HMD solution in water, and 1584 g of glacial acetic. The solution was then heated while the pressure was allowed to rise to 265 psia at which point, steam was vented to maintain the pressure at 265 psia and heating was continued until the temperature of the batch reached 250° C. The pressure was then reduced slowly to 6 psia, while the batch temperature was allowed to further rise to 280-290° C. The pressure was then held at 6 psia and the temperature was held at 280-290° C. for 20 minutes. Finally, the polymer melt was extruded into strands, cooled, and cut into pellets. PA66 refers to an aliphatic polyamide made of 1,6-hexanedioic acid and 1,6-hexamethylenediamine having a typical relative viscosity of 49 and a melting point of about 263° C., commercially available from E.I. DuPont de Nemours and Company, Wilmington, Del., USA under the trademark Zytel® 101NC010 polyamide.

PA 6 refers to Ultramid® B27 polyamide 6 resin (polycaprolactam) available from BASF Corporation, Florham Park, N.J., 07932.

Glass fibers A refer NEC D187H glass fibers manufactured by Nippon Electric Glass, Osaka, Japan.

Glass fiber B refers to CRC 301 HP chopped glass fiber available from Chongqing Polycomp International Corp., Chongqing, China.

Black Pigment A refers to ZYTEL® FE3786 BK031C black concentrate, a 40 wt % nigrosine black pigment concentrate in a PA66 carrier.

Black Pigment B refers ZYTEL FE3779 BK031C black concentrate, a 25 wt % carbon black in a PA6 carrier.

Cu heat stabilizer refers to a mixture of 7 parts of potassium iodide and 1 part of copper iodide in 0.5 part of aluminum stearate wax binder.

Aluminum distearate is a wax supplied by PMC Global, Inc. Sun Valley, Calif., USA.

Lico ax OP is a lubricant manufactured by Clariant Corp., Charlotte,

NC.

Kemamide E180 lubricant is N-stearylerucamide, CAS No, [10094-45-8], available from Chemtura Corp., Philadelphia, Pa.

TRX®301 copolymer refers to a maleic anhydride modified EPDM from available from E.I. DuPont de Nemours and Company, Wilmington, Del., USA.

EPON™ Resin 1009F is a high molecular weight solid epoxy resin (2300-3600 equivalent weight epoxy) derived from a liquid epoxy resin and bisphenol-A, available from Momentive, Inc., Columbus, Ohio.

EPON™ Resin 1002F is an epoxy resin (600-700 equivalent weight epoxy) derived from a liquid epoxy resin and bisphenol-A, available from Momentive, Inc., Columbus, Ohio.

Araldite 506 refers to a liquid epoxy resin (172-185 equivalent weight) manufactured by Huntsman Advanced Materials, Houston, Tex.

Elvaloy® 4170 resin refers to an ethylene/butyl acrylate/glycidyl methacrylate copolymer manufactured by E.I. DuPont de Nemours and Company, Wilmington, Del., USA

D.E.R.® 6508 epoxy resin has an epoxy equivalent weight of about 380-420 and functionality of 2 epoxys per molecule, available from Dow Chemical Co.

DDDA refers to dodecanedioic acid available from Aldrich Chemical Co., Milwaukee, Wis.

DPE refers to dipentaerythritol that was from Perstorp Speciality Chemicals AB, Perstorp, Sweden as Di-Penta 93.

Dimethylol propionic acid was available from available from Aldrich Chemical Co., Milwaukee, Wis.

EDTA refers ethylenediaminetetaacetic acid, available from Aldrich Chemical Co., Milwaukee, Wis.

TTE refers to trimethylolpropane triglycidyl ether having an epoxy equivalent weight of 138-154 available from Sigma-Aldrich.

### EXAMPLES

Examples and Comparative Examples for various embodiments are listed in Tables 1-20.

Tensile strength retention after air oven aging (AOA): and melt viscosity and melt viscosity retention were important performance parameters for injection molded parts. Example 1 and 2 illustrated that thermoplastic composition including a polyepoxy compound and a polyacid compound showed significantly higher AOA (1000 h, 230° C.) tensile strength retention than comparative examples C-1, absent polyepoxy and polyacid; and C-2, absent polyacid but with a polyepoxy compound. Comparative examples C-3, C-4 and C-5 indicate that amino polyacids (for instance, EDTA)+polyepoxy compound perform no better than amino polyacids alone. Other tables illustrated the AOA tensile strength retention under specific conditions.

TABLE 2

| Example | C-1 | C-2 | 1 | 2 | C-3 | C-4 | C-5 | C-6 |
|---|---|---|---|---|---|---|---|---|
| Polyamide B | 63.17 | 62.17 | 61.17 | 60.17 | 61.17 | 60.17 | 62.75 | 62.17 |
| (66/6T) | | | | | | | | |
| Glass Fiber B | 35.00 | 35.00 | 35.00 | 35.00 | 35.0 | 35.0 | 35.0 | 35.0 |
| Kemamide E180 | 0.10 | | 0.10 | 0.10 | 0.10 | 0.10 | | 0.10 |
| Licowax OP | | | | | | | 0.25 | |
| Aluminum | | 0.10 | | | | | | |
| Stearate | | | | | | | | |
| Cu Heat | 0.30 | 0.30 | 0.30 | 0.30 | 0.30 | 0.30 | | 0.30 |
| Stabilizer | | | | | | | | |
| Epon 1009F | | 1.00 | 1.00 | 1.00 | 1.00 | 1.00 | | |
| DDDA | | | 1.00 | 2.00 | | | | 1.00 |
| EDTA | | | | | 1.00 | 2.00 | 2.00 | |
| Black Pigment A | 0.60 | 0.60 | 0.60 | 0.60 | 0.60 | 0.60 | | 6.60 |
| Black Pigment B | 0.83 | 0.83 | 0.83 | 0.83 | 0.83 | 0.83 | | 0.83 |

Tensile Properties, Dry-As-Molded

| | | | | | | | | |
|---|---|---|---|---|---|---|---|---|
| TS [MPa] | 190 | 213 | 210 | 210 | 207 | 208 | 206 | 213 |
| EB [%] | 6.6 | 5.4 | 5.1 | 4.5 | 5.1 | 4.5 | 5.3 | 6.0 |

AOA, 500 h at 230° C.

| | | | | | | | | |
|---|---|---|---|---|---|---|---|---|
| TS [MPa] | 52 | 91 | 143 | 132 | 151 | 161 | 151 | 88 |
| TS Retention [%] | 28% | 43% | 88% | 63% | 73% | 77% | 73% | 41% |
| EB [%] | 1.8 | 1.2 | 3.5 | 3.2 | 4.0 | 3.9 | 2.8 | 1.5 |
| EB Retention [%] | 27% | 23% | 69% | 71% | 79% | 86% | 52% | 25% |

AOA Properties, 1000 h at 230° C.

| | | | | | | | | |
|---|---|---|---|---|---|---|---|---|
| TS [MPa] | 1 | 6 | 133 | 118 | 91 | 76 | 87 | 63 |
| TS Retention [%] | 1% | 3% | 63% | 56% | 44% | 36% | 42% | 30% |
| EB [%] | 0.2 | 0.4 | 2.0 | 1.8 | 1.8 | 1.4 | 3.0 | 1.7 |
| EB Retention [%] | 3% | 7% | 39% | 39% | 35% | 31% | 56% | 28% |

Melt Viscosity @ 280° C./290° C.

| | | | | | | | | |
|---|---|---|---|---|---|---|---|---|
| MV @ 5 min, | 248.1* | N/A | 142.7 | 61.0 | 168.4 | 80.1 | N/A | 186.7 |
| Pa · s | | | | | | | | |
| MV @ 25 min, | 205.7* | N/A | 127.0 | 57.6 | 146.2 | 72.1 | N/A | 172.2 |
| Pa · s | | | | | | | | |
| % MV Retention | 83% | N/A | 89% | 94% | 87% | 90% | N/A | 92% |

*Melt viscosity measured at 280° C.
In all tables, TS = tensile strength and EB = elongation to break

TABLE 3

| | Example | | | |
|---|---|---|---|---|
| | C-1 | C-7 | C-8 | 3 |
| Polyamide B (66/6T) | 63.17 | 62.17 | 61.17 | 59.10 |
| Glass Fiber B | 35.00 | 35.00 | 35.00 | 35.00 |
| Kemamide E180 | 0.10 | 0.10 | 0.10 | 0.10 |
| Cu Heat Stabilizer | 0.30 | 0.30 | 0.30 | 0.30 |
| Epon 1002F | | 1.00 | 2.00 | 2.00 |
| DDDA | | | | 2.00 |
| Black Pigment A | 0.60 | 0.60 | 0.60 | 0.67 |
| Black Plgment B | 0.83 | 0.83 | 0.83 | 0.83 |

Tensile Properties, Dry-As-Molded

| | | | | |
|---|---|---|---|---|
| TS [MPa] | 190 | 215 | 212 | 197 |
| EB [%] | 6.6 | 5.4 | 5.6 | 5.6 |

AOA, 500 h at 230° C.

| | | | | |
|---|---|---|---|---|
| TS [MPa] | 52 | 128 | 140 | 112 |
| TS Retention [%] | 28% | 59% | 66% | 57% |
| EB [%] | 1.8 | 1.7 | 1.8 | 1.6 |
| EB Retention [%] | 27% | 30% | 32% | 29% |

AOA Properties, 1000 h at 230° C.

| | | | | |
|---|---|---|---|---|
| TS [MPa] | 1 | 20 | 66 | 135 |
| TS Retention [%] | 1% | 9% | 31% | 69% |
| EB [%] | 0.2 | 0.4 | 1.1 | 2.1 |
| EB Retention [%] | 3% | 7% | 20% | 37% |

Melt Viscosity @ 280° C./290° C.

| | | | | |
|---|---|---|---|---|
| MV @ 5 min, Pa · s | 248.1* | N/A | N/A | 89.5 |
| MV @ 25 min, Pa · s | 205.7* | N/A | N/A | 75.6 |
| % MV Retention | 83% | N/A | N/A | 85% |

TABLE 4

| Example | | | | |
|---|---|---|---|---|
| 4 | 5 | 6 | 7 | C-9 |

| | | | | | |
|---|---|---|---|---|---|
| Polyamide B | 61.67 | 61.17 | 60.67 | 60.17 | 62.17 |
| (66/6T) | | | | | |
| Glass Fiber B | 35.00 | 35.00 | 35.00 | 35.00 | 35.00 |
| Kemamide E180 | 0.10 | 0.10 | 0.10 | 0.10 | 0.10 |
| Cu Heat Stabilizer | 0.30 | 0.30 | 0.30 | 0.30 | 0.30 |
| TTE (method 1) | 1.00 | 1.00 | 1.00 | 1.00 | |
| DDDA | 0.50 | 1.00 | 1.50 | 2.00 | 1.00 |
| Black Pigment A | 0.60 | 0.60 | 0.60 | 0.60 | 0.60 |
| (40% nigrosine in | | | | | |
| PA66) | | | | | |
| Black Pigment B | 0.83 | 0.83 | 0.83 | 0.83 | 0.83 |
| (25% carbon black | | | | | |
| in PA6) | | | | | |

Tensile Properties, Dry-As-Molded

| | | | | | |
|---|---|---|---|---|---|
| TS [MPa] | 200 | 207 | 207 | 207 | 213 |
| Elongation at | 4.2 | 4.1 | 3.9 | 3.3 | 6.0 |
| Break [%] | | | | | |

AOA, 500 h at 230° C.

| | | | | | |
|---|---|---|---|---|---|
| TS [MPa] | 205 | 205 | 202 | 159 | 88 |
| TS Retention [%] | 102% | 99% | 97% | 77% | 41% |
| EB [%] | 3.8 | 3.3 | 3.0 | 2.1 | 1.5 |
| EB Retention [%] | 92% | 81% | 78% | 62% | 25% |

AOA Properties, 1000 h at 230° C.

| | | | | | |
|---|---|---|---|---|---|
| TS [MPa] | 214 | 217 | 209 | 162 | 63 |
| TS Retention [%] | 107% | 105% | 101% | 78% | 30% |
| EB [%] | 3.8 | 3.4 | 3.1 | 2.1 | 1.7 |
| EB Retention [%] | 91% | 83% | 81% | 63% | 28% |

Melt Viscosity @ 280° C.

| | | | | | |
|---|---|---|---|---|---|
| MV @ 5 min, Pa · s | 406.3 | 355.3 | 240.9 | 139.2 | 186.7 |
| MV @ 25 min, | 341.3 | 331.7 | 322.8 | 125.5 | 172.2 |
| Pa · s | | | | | |
| % MV Retention | 84% | 93% | 134% | 90% | 92% |

TABLE 5

| Example | 8 | 9 | 10 | 11 | 12 | 13 | 14 | 15 | 16 |
|---|---|---|---|---|---|---|---|---|---|
| Polyamide B | 54.67 | 55.17 | 54.17 | 54.67 | 55.67 | 56.17 | 55.67 | 55.17 | 55.17 |
| (66/6T) | | | | | | | | | |
| Polyamide C | 5.00 | 5.00 | 5.00 | 5.00 | 5.00 | 5.00 | 5.00 | 5.00 | 5.00 |
| (PA6) | | | | | | | | | |
| Ultramid B27 | | | | | | | | | |
| Glass Fiber B | 35.00 | 35.00 | 35.00 | 35.00 | 35.00 | 35.00 | 35.00 | 35.00 | 35.00 |
| [CPIC] | | | | | | | | | |
| Kemamide | 0.10 | 0.10 | 0.10 | 0.10 | 0.10 | 0.10 | 0.10 | 0.10 | 0.10 |
| E180 | | | | | | | | | |
| Cu Heat | 0.30 | 0.30 | 0.30 | 0.30 | 0.30 | 0.30 | 0.30 | 0.30 | 0.30 |
| Stabilizer | | | | | | | | | |
| Epon 1009F | 2.00 | 1.50 | 2.00 | 1.50 | 1.00 | 1.00 | 1.50 | 2.00 | 1.00 |
| DDDA | 1.50 | 1.50 | 2.00 | 2.00 | 1.50 | 1.00 | 1.00 | 1.00 | 2.00 |
| Black | 0.60 | 0.60 | 0.60 | 0.60 | 0.60 | 0.60 | 0.60 | 0.60 | 0.60 |
| Pigment A | | | | | | | | | |
| Black | 0.83 | 0.83 | 0.83 | 0.83 | 0.83 | 0.83 | 0.83 | 0.83 | 0.83 |
| Pigment B | | | | | | | | | |

Tensile Properties, Dry-As-Molded

| | | | | | | | | | |
|---|---|---|---|---|---|---|---|---|---|
| TS [MPa] | 196 | 195 | 175 | 184 | 195 | 195 | 192 | 198 | 189 |
| EB [%] | 3.4 | 3.2 | 2.8 | 2.8 | 3.1 | 3.4 | 3.5 | 3.4 | 3.0 |

AOA, 500 h at 230° C.

| | | | | | | | | | |
|---|---|---|---|---|---|---|---|---|---|
| TS [MPa] | 141 | 139 | 140 | 131 | 131 | 153 | 126 | 114 | 129 |
| TS Retention | 72% | 71% | 80% | 71% | 67% | 79% | 65% | 57% | 68% |
| [%] | | | | | | | | | |
| EB [%] | 1.9 | 1.9 | 1.9 | 1.8 | 1.8 | 2.1 | 1.7 | 1.6 | 1.8 |
| EB Retention | 56% | 60% | 69% | 64% | 57% | 62% | 50% | 47% | 60% |
| [%] | | | | | | | | | |

AOA Properties, 1000 h at 230° C.

| | | | | | | | | | |
|---|---|---|---|---|---|---|---|---|---|
| TS [MPa] | 148 | 174 | 178 | 187 | 155 | 168 | 140 | 129 | 136 |
| TS Retention | 75% | 89% | 101% | 102% | 79% | 86% | 73% | 65% | 72% |
| [%] | | | | | | | | | |
| EB [%] | 2.1 | 2.5 | 2.5 | 2.7 | 2.2 | 2.4 | 2.0 | 1.9 | 1.9 |
| EB Retention | 63% | 78% | 89% | 95% | 70% | 70% | 57% | 54% | 64% |
| [%] | | | | | | | | | |

Melt Viscosity @ 290° C.

| | | | | | | | | | |
|---|---|---|---|---|---|---|---|---|---|
| MV @ 5 min, | 129.6 | 78.7 | 54.4 | 57.6 | 66.8 | 96.6 | 76.7 | 105.2 | 55.8 |
| Pa · s | | | | | | | | | |
| MV @ 25 min, | 124.6 | 81.9 | 53.1 | 52.6 | 67.8 | 97.9 | 70.3 | 99.5 | 51.7 |
| Pa · s | | | | | | | | | |
| MV Retention | 96 | 104 | 98 | 91 | 101 | 101 | 92 | 95 | 93 |
| [%] | | | | | | | | | |

TABLE 6

| | Example | | | | |
|---|---|---|---|---|---|
| | 17 | 18 | 19 | 20 | C-10 |
| Polyamide B (66/6T) | 61.67 | 61.17 | 60.67 | 60.17 | 62.17 |
| Glass Fiber B | 35.00 | 35.00 | 35.00 | 35.00 | 35.00 |
| Kemamide E180 | 0.10 | 0.10 | 0.10 | 0.10 | 0.10 |
| Cu Heat | 0.30 | 0.30 | 0.30 | 0.30 | 0.30 |
| Stabilizer | | | | | |
| TTE (method 2) | 1.00 | 1.00 | 1.00 | 1.00 | 1.00 |
| DDDA | 0.50 | 1.00 | 1.50 | 2.00 | |
| Black Pigment A | 0.60 | 0.60 | 0.60 | 0.60 | 0.60 |
| Black Pigment B | 0.83 | 0.83 | 0.83 | 0.83 | 0.83 |

Tensile Properties, Dry-As-Molded

| | | | | | |
|---|---|---|---|---|---|
| TS [MPa] | 205 | 204 | 202 | 191 | 202 |
| EB [%] | 3.6 | 3.4 | 3.3 | 2.9 | 3.5 |

AOA, 500 h at 230° C.

| | | | | | |
|---|---|---|---|---|---|
| TS [MPa] | 174 | 187 | 186 | 155 | 174 |
| TS Retention [%] | 85% | 92% | 92% | 81% | 86% |
| EB [%] | 2.3 | 2.7 | 2.6 | 2.1 | 2.4 |
| EB Retention [%] | 64% | 80% | 80% | 73% | 67% |

AOA Properties, 1000 h at 230° C.

| | | | | | |
|---|---|---|---|---|---|
| TS [MPa] | 174 | 169 | 187 | 153 | 142 |
| TS Retention [%] | 85% | 83% | 93% | 80% | 70% |
| EB [%] | 2.3 | 2.2 | 2.6 | 2.0 | 1.9 |
| EB Retention [%] | 65% | 65% | 79% | 69% | 54% |

Melt Viscosity @ 290° C.

| | | | | | |
|---|---|---|---|---|---|
| MV @ 5 min, | 207.7 | 227.9 | 221.5 | 109.4 | 329.9 |
| Pa · s | | | | | |
| MV @ 25 min, | 173.9 | 165.8 | 144.5 | 91.0 | 298.6 |
| Pa · s | | | | | |
| % MV Retention | 84% | 73% | 65% | 83% | 91% |

TABLE 7

| | Example | | |
|---|---|---|---|
| | C-1 | C-11 | 21 |
| Polyamide B (66/6T) | 63.17 | 62.17 | 61.17 |
| Glass Fiber B | 35.00 | 35.00 | 35.00 |
| Kemamide E180 | 0.10 | 0.10 | 0.10 |
| Cu Heat Stabilizer | 0.30 | 0.30 | 0.30 |
| Araldite 506 | | 1.00 | 1.00 |
| DDDA | | | 1.00 |
| Black Pigment A | 0.60 | 0.60 | 0.60 |
| Black Pigment B | 0.83 | 0.83 | 0.83 |

Tensile Properties, Dry-As-Molded

| | | | |
|---|---|---|---|
| TS [MPa] | 190 | 157 | 170 |
| EB [%] | 6.6 | 2.7 | 2.8 |

AOA, 500 h at 230° C.

| | | | |
|---|---|---|---|
| TS [MPa] | 52 | 99 | 137 |
| TS Retention [%] | 28% | 63% | 80% |
| EB [%] | 1.8 | 1.3 | 1.9 |
| EB Retention [%] | 27% | 48% | 68% |

AOA Properties, 1000 h at 230° C.

| | | | |
|---|---|---|---|
| TS [MPa] | 1 | 33 | 109 |
| TS Retention [%] | 1% | 21% | 64% |
| EB [%] | 0.2 | 0.7 | 1.6 |
| EB Retention [%] | 3% | 29% | 56% |

Melt Viscosity @ 280° C./290° C.

| | | | |
|---|---|---|---|
| MV @ 5 min, Pa · s | 248.1* | 251.8 | 211.7 |
| MV @ 25 min, Pa · s | 205.7* | 202.0 | 146.5 |
| % MV Retention | 83% | 80% | 69% |

Method 1 used in Examples C-11 and 21

TABLE 8

| | Example | | | | |
|---|---|---|---|---|---|
| | C-12 | C-13 | 22 | 23 | 24 |
| Polyamide B (66/6T) | 61.67 | 60.17 | 59.67 | 58.50 | 58.50 |
| Glass Fiber B | 35.00 | 35.00 | 35.00 | 35.00 | 35.00 |
| Cu Heat Stabilizer | 0.30 | 0.30 | 0.30 | 0.30 | 0.30 |
| DPE | 1.50 | 3.00 | 2.00 | 3.00 | 2.00 |
| TTE (method 1) | | | 1.00 | 1.00 | 2.00 |
| DDDA | | | 0.50 | 0.50 | 0.50 |
| Black Pigment A | 0.60 | 0.60 | 0.60 | 1.00 | 1.00 |
| Black Pigment B | 0.83 | 0.83 | 0.83 | 0.60 | 0.60 |
| Kemamide E180 | 0.10 | 0.10 | 0.10 | 0.10 | 0.10 |

Tensile Properties, Dry-As-Molded

| | | | | | |
|---|---|---|---|---|---|
| TS [MPa] | 208 | 213 | 215 | 206 | 202 |
| EB [%] | 3.8 | 3.9 | 6.0 | 4.9 | 5.1 |

AOA, 500 h at 230° C.

| | | | | | |
|---|---|---|---|---|---|
| TS [MPa] | 128 | 169 | 166 | 225 | 222 |
| TS Retention [%] | 61% | 79% | 78% | 109% | 111% |
| EB [%] | 3.1 | 3.8 | 3.8 | 4.4 | 4.5 |
| EB Retention [%] | 80% | 98% | 63% | 88% | 88% |

AOA Properties, 1000 h at 230° C.

| | | | | | |
|---|---|---|---|---|---|
| TS [MPa] | 13 | 71 | 120 | 171 | 160 |
| TS Retention [%] | 6% | 34% | 56% | 83% | 79% |
| EB [%] | 0.3 | 1.9 | 3.9 | 4.1 | 3.9 |
| EB Retention [%] | 8% | 50% | 65% | 83% | 77% |

Melt Viscosity @ 290° C.

| | | | | | |
|---|---|---|---|---|---|
| MV @ 5 min | 206.7 | 141.2 | 166.9 | 161.8 | 241.0 |
| MV @ 25 min | 142.1 | 69.2 | 115.0 | 144.2 | 222.9 |
| % MV Retention | 69% | 49% | 69% | 89% | 92% |
| Whitening | | | | | |
| ΔL (110°) 24 hours | 19.1 | 38.2 | 30.1 | N/A | N/A |
| Characterization 24 hrs | moderate | severe | severe | N/A | N/A |
| ΔL (110°) 7 days | 42.3 | 52.1 | 53.3 | N/A | N/A |
| Characterization | severe | severe | severe | N/A | N/A |
| 7 days | | | | | |

TABLE 9

Example

| | C-14 | 25 |
|---|---|---|
| PA66/6T | 62.40 | 61.40 |
| Glass Fiber B | 35.00 | 35.00 |
| Cu Heat Stabilizer | 0.30 | 0.30 |
| Black Pigment A | 0.60 | 0.60 |
| Black Pigment B | 0.60 | 0.60 |
| Kemamide E180 | 0.10 | 0.10 |
| TTE (method 3) | 1.00 | 1.00 |
| Dimethylol propionic acid | | 1.00 |

Tensile Properties, Dry-As-Molded

| | | |
|---|---|---|
| TS [MPa] | 213 | 239 |
| EB [%] | 3.5 | 3.7 |

AOA, 500 h at 230° C.

| | | |
|---|---|---|
| TS [MPa] | 129 | 185 |
| TS Retention [%] | 61% | 77% |
| EB [%] | 1.8 | 2.8 |
| EB Retention [%] | 51% | 74% |

AOA Properties, 1000 h at 230° C.

| | | |
|---|---|---|
| TS [MPa] | 53 | 150 |
| TS Retention [%] | 25% | 63% |
| EB [%] | 1.2 | 3.1 |
| EB Retention [%] | 34% | 84% |

TABLE 10A
(Controls)

| | Examples | | | | |
|---|---|---|---|---|---|
| | C-15 | C-16 | C-17 | C-18 | C-19 |
| PA 66 | | | 63.00 | | 64.00 |
| Polyamide B (PA 66/6T) | | 63.00 | 63.00 | | |
| Polyamide A (PA6T/66) | 63.07 | | | | |
| Glass Fiber A | 35.00 | 35.00 | 35.00 | 35.00 | 36.00 |
| Kemamide E180 | 0.10 | 0.10 | 0.10 | 0.10 | 1.10 |
| Cu Heat Stabilizer | 0.40 | 0.3 | 0.3 | 0.3 | 1.3 |
| Black Pigment A | 0.60 | 0.60 | 0.60 | 0.60 | 1.60 |
| Black Pigment B | 0.83 | 1.00 | 1.00 | 1.00 | 2.00 |

Tensile Properties, Dry-As Molded

| | | | | | |
|---|---|---|---|---|---|
| TS [MPa] | 221 | 188 | 203 | 208 | 209 |
| EB [%] | 3.1 | 5.2 | 5.5 | 5.4 | 6.4 |

AOA, 500 h at 230° C.

| | | | | | |
|---|---|---|---|---|---|
| TS [MPa] | 136 | 56 | 55 | 41 | 42 |
| TS Retention [%] | 62% | 30% | 27% | 20% | 20% |
| EB [%] | 1.7 | 1.7 | 1.4 | 1.2 | 2.2 |
| EB Retention [%] | 54% | 32% | 25% | 22% | 34% |

AOA, 1000 h at 230° C.

| | | | | | |
|---|---|---|---|---|---|
| TS [MPa] | 90 | 0 | 0 | 0 | 1 |
| TS Retention [%] | 41% | 0% | 0% | 0% | 0% |
| EB [%] | 1.6 | 0.0 | 0.0 | 0.0 | 1.0 |
| EB Retention [%] | 51% | 0% | 0% | 0% | 100% |

30 mm extruder, 30 lb/h, 300 rpm, 280° C. barrel temperature.

Table 10A lists PA 66, PA 6616T and PA 6T/66 Controls, absent polyepoxy and carboxylic acid compounds. Two distinct runs of PA 66 and PA 66/6T show no tensile strength retention under AOA at 230° C./1000 h.

TABLE 10B
(Controls)

| Examples | C-20 | C-21 | C-22 | C-23 | C-24 | C-25 | C-26 |
|---|---|---|---|---|---|---|---|
| PA 66 | | | 63.00 | 63.00 | 63.00 | 63.00 | 63.00 |
| Polyamide B | 63.00 | 63.00 | | | | | |
| Glass fiber A | 35.00 | 35.00 | 35.00 | 35.00 | 35.00 | 35.00 | 35.00 |
| Kemamide E180 | 0.10 | 0.10 | 0.10 | 0.10 | 0.10 | 0.10 | 0.10 |
| Cu Heat | 0.3 | 0.3 | 0.3 | 0.3 | 0.3 | 0.3 | 0.3 |
| Stabilizer | | | | | | | |
| Black | 0.60 | 0.60 | 0.60 | 0.60 | 0.60 | 0.60 | 0.60 |
| concentrate A | | | | | | | |
| Black | 1.00 | 1.00 | 1.00 | 1.00 | 1.00 | 1.00 | 1.00 |
| concentrate B | | | | | | | |

Tensile Properties, Dry-As Molded

| | | | | | | | |
|---|---|---|---|---|---|---|---|
| TS [MPa] | 198 | 197 | 199 | 200 | 200 | 198 | 199 |
| EB [%] | 5.7 | 5.3 | 5.5 | 5.5 | 5.5 | 5.4 | 5.3 |

AOA, 500 h at 230° C.

| | | | | | | | |
|---|---|---|---|---|---|---|---|
| TS [MPa] | 61 | 60 | 0 | 0 | 0 | 0 | 0 |
| TS Retention [%] | 31% | 30% | 0% | 0% | 0% | 0% | 0% |
| EB [%] | 1.3 | 1.7 | 0.0 | 0.0 | 0.0 | 0.0 | 0.0 |
| EB Retention [%] | 23% | 32% | 0% | 0% | 0% | 0% | 0% |

AOA, 1000 h at 230° C.

| | | | | | | | |
|---|---|---|---|---|---|---|---|
| TS [MPa] | 0 | 0 | 0 | 0 | 0 | 0 | 0 |
| TS Retention [%] | 0% | 0% | 0% | 0% | 0% | 0% | 0% |
| EB [%] | 0.0 | 0.0 | 0.0 | 0.0 | 0.0 | 0.0 | 0.0 |
| EB Retention [%] | 0% | 0% | 0% | 0% | 0% | 0% | 0% |

Melt Viscosity @ 290° C.

| | | | | | | | |
|---|---|---|---|---|---|---|---|
| MV @ 5 min | 278 | 226 | 263 | 236 | 219 | 226 | 235 |
| MV @ 25 min | 271 | 171 | 216 | 213 | 187 | 216 | 206 |
| % MV Retention | 98% | 76% | 82% | 90% | 85% | 96% | 88% |
| Mass flow rate | 200 | 350 | 175 | 225 | 225 | 325 | 350 |
| (lb/h) | | | | | | | |
| Screw speed | 250 | 500 | 300 | 300 | 500 | 500 | 500 |
| (rpm) | | | | | | | |

40 mm extruder, 280° C. barrel temperature.

Table 10B lists PA 66 and PA 66/6T compositions, absent polyepoxy and carboxylic acid compounds, processed under various conditions in a 40 mm extruder, showing 0% tensile strength retention under AOA at 230° C./1000 h.

TABLE 10C
(Controls)

| | Example | | |
|---|---|---|---|
| | C-27 | C-28 | C-29 |
| Polyamide B (PA 66/6T) | 60.67 | 61.67 | 61.17 |
| Glass Fiber A | 35.00 | 35.00 | 35.00 |
| Kemamide E180 | 0.10 | 0.10 | 0.10 |
| Cu Heat Stabilizer | 0.30 | 0.30 | 0.30 |
| Black concentrate A | 0.60 | 0.60 | 0.60 |
| Black concentrate B | 0.83 | 0.83 | 0.83 |
| Elvaloy ® 4170 resin | 1.00 | | |
| DDDA | 1.50 | 1.50 | 2.00 |

Tensile Properties, Dry-As
Molded

| | | | |
|---|---|---|---|
| Tensile Strength [MPa] | 207 | 203 | 201 |
| Elongation at Break [%] | 3.6 | 3.3 | 3.0 |

AOA, 500 h at 230° C.

| | | | |
|---|---|---|---|
| Tensile Strength [MPa] | 93 | 142 | 130 |
| Tensile Strength Retention [%] | 45% | 70% | 64% |
| Elongation at Break [%] | 2.4 | 4.0 | 3.6 |
| Elongation at Break Retention [%] | 67% | 124% | 119% |

AOA, 1000 h at 230° C.

| | | | |
|---|---|---|---|
| Tensile Strength [MPa] | 0 | 66 | 0 |
| Tensile Strength Retention [%] | 0% | 33% | 0% |
| Elongation at Break [%] | 0 | 2.4 | 0 |
| Elongation at Break Retention [%] | 0% | 72% | 0% |

30 mm extruder, 30 lb/h, 300 rpm 280° C.

Table 100 lists PA 66/6T compositions having carboxylic acid compound, but absent polyepoxy compound as defined herein. Comparative Example C-27 includes an ethylene/butyl acrylate/glycidyl methacrylate (EBAGMA) copolymer with number average molecular weight and epoxy equivalent weight outside the limits of the invention.

TABLE 11

| | Examples | | | | |
|---|---|---|---|---|---|
| | 26 | 27 | 28 | 29 | 30 |
| Polyamide B (PA66/6T) | 60.25 | 60.50 | 59.75 | 60.00 | 60.25 |
| Glass Fiber A | 35.00 | 35.00 | 35.00 | 35.00 | 35.00 |
| Black concentrate A | 0.60 | 0.60 | 0.60 | 0.60 | 0.60 |
| Black concentrate B | 1.00 | 1.00 | 1.00 | 1.00 | 1.00 |
| Cu Heat Stabilizer | 0.30 | 0.30 | 0.30 | 0.30 | 0.30 |
| TTE | 1.25 | 1.25 | 1.50 | 1.50 | 1.50 |
| Kemamide E-180 | 0.10 | 0.10 | 0.10 | 0.10 | 0.10 |
| DDDA | 1.50 | 1.25 | 1.75 | 1.50 | 1.25 |

Tensile Properties, Dry-As Molded

| | | | | | |
|---|---|---|---|---|---|
| TS [MPa] | 205 | 194 | 198 | 204 | 191 |
| EB [%] | 5.1 | 4.5 | 4.6 | 4.8 | 4.4 |

AOA, 500 h at 230° C.

| | | | | | |
|---|---|---|---|---|---|
| TS [MPa] | 125 | 131 | 130 | 131 | 134 |
| TS Retention [%] | 61% | 67% | 66% | 64% | 70% |
| EB [%] | 3.4 | 3.4 | 2.9 | 3.3 | 3.4 |
| EB Retention [%] | 67% | 75% | 63% | 68% | 78% |

AOA, 1000 h at 230° C.

| | | | | | |
|---|---|---|---|---|---|
| TS [MPa] | 48 | 69 | 71 | 61 | 72 |
| TS Retention [%] | 24% | 35% | 36% | 30% | 38% |
| EB [%] | 0.9 | 1.9 | 2.3 | 1.8 | 2.3 |
| EB Retention [%] | 18% | 42% | 50% | 38% | 52% |

Melt Viscosity @ 290° C.

| | | | | | |
|---|---|---|---|---|---|
| MV @ 5 min [Pa · s] | 192 | 169 | 97 | 110 | 107 |
| MV @ 25 min [Pa · s] | 108 | 109 | 76 | 81 | 82 |
| MV Retention | 56% | 64% | 78% | 74% | 77% |

40 mm extruder, 350 lb/h, 500 rpm, 280° C. barrel temperature.

Table 11 lists several Examples of PA 66/6T compositions processed in a 40 mm extruder. The examples show tensile strength retention (230° C./1000 h) that are significantly higher than the comparative examples, absent polyepoxy and carboxylic acid compounds, listed in Table 11. However the tensile strength retentions are significantly different than that of Examples listed in Table 4, processed using a 30 mm extruder.

TABLE 12

| | Examples | | | |
|---|---|---|---|---|
| | C-30 | 31 | C-31 | 32 |
| Polyamide A (PA6T/66) | 62.07 | 60.57 | 61.07 | 59.57 |
| Glass Fiber A | 35.00 | 35.00 | 35.00 | 35.00 |
| Cu Heat Stabilizer | 0.40 | 0.40 | 0.40 | 0.40 |
| TTE | 1.00 | 1.00 | | |
| Epon 1009F | | | 2.00 | 2.00 |
| DDDA | | 1.50 | | 1.50 |
| Black concentrate A | 0.60 | 0.60 | 0.60 | 0.60 |
| Black concentrate B | 0.83 | 0.83 | 0.83 | 0.83 |
| Kemamide E180 | 0.10 | 0.10 | 0.10 | 0.10 |

Tensile Properties, Dry-As Molded

| | | | | |
|---|---|---|---|---|
| TS [MPa] | 218 | 208 | 218 | 199 |
| EB [%] | 2.8 | 2.6 | 3.0 | 2.5 |

AOA, 500 h at 230° C.

| | | | | |
|---|---|---|---|---|
| TS [MPa] | 176 | 183 | 141 | 116 |
| TS Retention [%] | 81% | 88% | 65% | 58% |
| EB [%] | 2.0 | 2.3 | 1.7 | 1.5 |
| EB Retention [%] | 72% | 86% | 56% | 60% |

AOA, 1000 h at 230° C.

| | | | | |
|---|---|---|---|---|
| Tensile Strength [MPa] | 73 | 173 | 96 | 143 |
| TS Retention [%] | 34% | 83% | 44% | 72% |
| Elongation at Break [%] | 0.8 | 3.5 | 0.5 | 2.7 |
| EB Retention [%] | 27% | 133% | 16% | 108% |

30 mm extruder, 30 lb/h, 300 rpm, 310 barrel temperature.

Table 12 lists comparative examples including a polyepoxy, but absent a carboxylic acid compound. TS retention is significantly higher in Examples having both a polyepoxy and a carboxylic acid compound as defined herein.

TABLE 13

| | Example | | | |
|---|---|---|---|---|
| | 33 | 34 | C-32 | C-33 |
| Polyamide B (PA 66/6T) | 58.90 | 58.40 | 58.90 | 58.40 |
| Glass fiber A | 35.00 | 35.00 | 35.00 | 35.00 |
| Kemamide E180 | 0.10 | 0.10 | 0.10 | 0.10 |
| Black concentrate A | 1.00 | 1.00 | 1.00 | 1.00 |
| Black concentrate B | 1.00 | 1.00 | 1.00 | 1.00 |
| D.E.R. 6508 | 3.00 | 3.00 | 3.00 | 3.00 |
| DDDA | 1.00 | 1.50 | | |
| Terephthalic acid | | | 1.00 | 1.50 |

Tensile Properties, Dry-As
Molded

| | | | | |
|---|---|---|---|---|
| Tensile Strength [MPa] | 202 | 200 | 203 | 201 |
| Elongation at Break [%] | 3.8 | 3.4 | 3.5 | 3.4 |

AOA, 500 h at 230° C.

| | | | | |
|---|---|---|---|---|
| Tensile Strength [MPa] | 129 | 146 | 112 | 116 |
| Tensile Strength Retention [%] | 64% | 73% | 55% | 58% |
| Elongation at Break [%] | 1.7 | 2.0 | 1.5 | 1.4 |
| Elongation at Break Retention [%] | 46% | 58% | 43% | 42% |

AOA, 1000 h at 230° C.

| | | | | |
|---|---|---|---|---|
| Tensile Strength [MPa] | 68 | 103 | 17 | 10 |
| Tensile Strength Retention [%] | 33% | 51% | 8% | 5% |
| Elongation at Break [%] | 1.2 | 1.7 | 0.0 | 0.3 |
| Elongation at Break Retention [%] | 32% | 50% | 1% | 10% |

30 mm extruder, 300 rpm, and about 30 lb/h.

Table 13 lists Examples of PA 66/6T compositions having polyepoxy compound and dodecanedioic acid; and comparative examples of similar composition with terephtahlic add having a melting point greater than 280° C.

TABLE 14A

| | Examples | | | | |
|---|---|---|---|---|---|
| | C-34 | C-35 | C-36 | C-37 | C-38 |
| PA 66 | 60.00 | 59.50 | 58.50 | 59.00 | 58.00 |
| Glass fiber A | 35.00 | 35.00 | 35.00 | 35.00 | 35.00 |
| Kemamide E180 | 0.10 | 0.10 | 0.10 | 0.10 | 0.10 |
| Copper heat stabilizer | 0.30 | 0.30 | 0.30 | 0.30 | 0.30 |
| Black pigment A | 0.60 | 0.60 | 0.60 | 0.60 | 0.60 |
| Black pigment B | 1.00 | 1.00 | 1.00 | 1.00 | 1.00 |
| Epon 1009F | 1.50 | 2.00 | 2.50 | 2.50 | 3.00 |
| DDDA | 1.50 | 1.50 | 2.00 | 1.50 | 2.00 |

Tensile Properties, Dry-As Molded

| | | | | | |
|---|---|---|---|---|---|
| TS [MPa] | 194 | 189 | 180 | 186 | 181 |
| EB [%] | 4.6 | 4.6 | 4.1 | 4.4 | 4.1 |

AOA, 500 h at 230° C.

| | | | | | |
|---|---|---|---|---|---|
| TS [MPa] | 31 | 78 | 89 | 96 | 80 |
| TS Retention [%] | 16% | 41% | 49% | 52% | 44% |
| EBreak [%] | 0.6 | 2.2 | 2.4 | 2.8 | 1.9 |
| EB Retention [%] | 14% | 48% | 58% | 65% | 45% |

AOA, 1000 h at 230° C.

| | | | | | |
|---|---|---|---|---|---|
| TS [MPa] | 0 | 0 | 0 | 0 | 0 |
| TS Retention [%] | 0% | 0% | 0% | 0% | 0% |
| EB [%] | 0 | 0 | 0 | 0 | 0 |
| EB Retention [%] | 0% | 0% | 0% | 0% | 0% |

Melt Viscosity @ 290° C.

| | | | | | |
|---|---|---|---|---|---|
| MV @ 5 min | 31.6 | 52.2 | 34.4 | 54.8 | 37.8 |
| MV @ 25 min | 32.6 | 54.6 | 39.4 | 58.0 | 40.1 |
| % MV Retention | 103% | 105% | 115% | 106% | 106% |

40 mm extruder, 200 lb/h, 250 rpm, 280° C. barrel temperature.

Table 14A Comparative Examples were representative of the performance of PA 66 resin, absent a second polyamide resin. The polyepoxy compound (Epon 1009F) had an epoxy equivalent weight of about 2300-3600. PA 66 alone showed 0% TS retention after 230° C./1000 h AOA.

TABLE 14B

| Examples | C-39 | C-40 | C-41 | C-42 | C-43 | C-44 |
|---|---|---|---|---|---|---|
| PA 66 | 60.25 | 60.50 | 60.50 | 60.75 | 60.25 | 60.00 |
| Glass fiber A | 35.00 | 35.00 | 35.00 | 35.00 | 35.00 | 35.00 |
| Kemamide | 0.10 | 0.10 | 0.10 | 0.10 | 0.10 | 0.10 |
| E180 | | | | | | |
| Copper heat | 0.30 | 0.30 | 0.30 | 0.30 | 0.30 | 0.30 |
| stabilizer | | | | | | |
| Black pigment | 0.60 | 0.60 | 0.60 | 0.60 | 0.60 | 0.60 |
| A | | | | | | |
| Black pigment | 1.00 | 1.00 | 1.00 | 1.00 | 1.00 | 1.00 |
| B | | | | | | |
| TTE (method | 1.00 | 1.00 | 1.00 | 1.00 | 1.25 | 1.50 |
| 2) | | | | | | |
| DDDA | 1.75 | 1.50 | 1.50 | 1.25 | 1.50 | 1.50 |

Tensile Properties, Dry-As Molded

| | | | | | | |
|---|---|---|---|---|---|---|
| TS [MPa] | 210 | 205 | 205 | 208 | 207 | 204 |
| EB [%] | 4.9 | 4.8 | 4.7 | 5.1 | 5.0 | 5.2 |

AOA, 500 h at 230° C.

| | | | | | | |
|---|---|---|---|---|---|---|
| TS [MPa] | 95 | 147 | 86 | 90 | 230 | 225 |
| TS Retention | 45% | 72% | 42% | 43% | 111% | 110% |
| [%] | | | | | | |
| EB [%] | 2.4 | 2.5 | 2.1 | 1.6 | 5.2 | 5.5 |
| EB Retention | 49% | 51% | 44% | 31% | 105% | 106% |
| [%] | | | | | | |

AOA, 1000 h at 230° C.

| | | | | | | |
|---|---|---|---|---|---|---|
| TS [MPa] | 0 | 143 | 0 | 0 | 196 | 194 |
| TS Retention | 0% | 70% | 0% | 0% | 95% | 95% |
| [%] | | | | | | |
| EB [%] | 0 | 2.8 | 0 | 0 | 4.2 | 4.3 |
| EB Retention | 0% | 60% | 0% | 0% | 84% | 83% |
| [%] | | | | | | |

Melt Viscosity @ 290° C.

| | | | | | | |
|---|---|---|---|---|---|---|
| MV @ 5 min | 92.8 | 121.9 | 106.0 | 197.3 | 151.4 | 236.6 |
| MV @ 25 min | 82.5 | 114.2 | 93.6 | 173.9 | 112.0 | 116.6 |
| % MV | 89% | 94% | 88% | 88% | 74% | 49% |
| Retention | | | | | | |

Process conditions

| | | | | | | |
|---|---|---|---|---|---|---|
| Mass Flow | 200 | 200 | 350 | 200 | 200 | 200 |
| Rate (lb/h) | | | | | | |
| Screw Speed | 250 | 250 | 425 | 250 | 250 | 250 |
| (RPM) | | | | | | |

40 mm extruder, 280° C. barrel temperature.

Table 14B Comparative Examples were representative of the performance of PA 66 resin, absent a second polyamide resin. The polyepoxy compound (TTE) had an epoxy equivalent weight of about 138-154. PA 66 showed 0% TS retention after 230° C./1000 h AOA under several processing conditions and high TS retention under others within the same iterative series.

TABLE 14C

| Examples | C-45 | C-46 | C-47 | C-48 | C-49 | C-50 |
|---|---|---|---|---|---|---|
| PA 66 | 60.50 | 60.25 | 59.88 | 59.85 | 60.00 | 60.00 |
| Glass fiber A | 35.00 | 35.00 | 35.00 | 35.00 | 35.00 | 35.00 |
| Kemamide | 0.10 | 0.10 | 0.10 | 0.10 | 0.10 | 0.10 |
| E180 | | | | | | |
| Copper heat | 0.30 | 0.30 | 0.30 | 0.30 | 0.30 | 0.30 |
| stabilizer | | | | | | |
| Black pigment | 0.60 | 0.60 | 0.60 | 0.60 | 0.60 | 0.60 |
| A | | | | | | |
| Black pigment | 1.00 | 1.00 | 1.00 | 1.00 | 1.00 | 1.00 |
| B | | | | | | |
| TTE (method | 1.00 | 1.25 | 1.25 | 1.35 | 1.50 | 1.50 |
| 2) | | | | | | |
| DDDA | 1.50 | 1.50 | 1.875 | 1.80 | 1.50 | 1.50 |

Tensile Properties, Dry-As Molded

| | | | | | | |
|---|---|---|---|---|---|---|
| TS [MPa] | 210 | 210 | 209 | 213 | 212 | 211 |
| EB [%] | 5.1 | 5.3 | 5.1 | 5.2 | 5.3 | 5.4 |

AOA, 500 h at 230° C.

| | | | | | | |
|---|---|---|---|---|---|---|
| TS [MPa] | 56 | 117 | 210 | 216 | 211 | 190 |
| TS Retention | 27% | 55% | 100% | 101% | 100% | 90% |
| [%] | | | | | | |
| EB [%] | 1.2 | 3.3 | 4.5 | 4.6 | 4.5 | 4.2 |
| EB Retention | 23% | 62% | 88% | 88% | 86% | 79% |
| [%] | | | | | | |
| TS [MPa] | 56 | 117 | 210 | 216 | 211 | 190 |

AOA, 1000 h at 230° C.

| | | | | | | |
|---|---|---|---|---|---|---|
| TS [MPa] | 0 | 0 | 217 | 178 | 157 | 20 |
| TS Retention | 0% | 0% | 104% | 83% | 74% | 9% |
| [%] | | | | | | |
| EB [%] | 0 | 0 | 4.6 | 3.8 | 2.9 | 0.4 |
| EB Retention | 0% | 0% | 91% | 73% | 56% | 7% |
| [%] | | | | | | |

Melt Viscosity @ 290° C.

| | | | | | | |
|---|---|---|---|---|---|---|
| MV @ 5 min | n/a | 196.0 | 71.0 | 88.0 | 120.0 | 133.0 |
| MV @ 25 min | n/a | 158.0 | 66.0 | 66.0 | 74.0 | 69.0 |
| % MV | n/a | 81% | 93% | 75% | 62% | 52% |
| Retention | | | | | | |

Process conditions

| | | | | | | |
|---|---|---|---|---|---|---|
| Mass Flow | 200 | 200 | 300 | 300 | 300 | 200 |
| Rate (lb/h) | | | | | | |
| Screw Speed | 250 | 250 | 500 | 500 | 500 | 250 |
| (RPM) | | | | | | |

40 mm extruder, 280° C. barrel temperature.

Table 14C Comparative Examples were representative of the performance of PA 66 resin; absent a second polyamide resin. The polyepoxy compound (TTE) had an epoxy equivalent weight of about 138-164. PA 66 showed 0% TS retention after 230° C./1000 h AOA under several processing conditions and high TS retention under others within the same iterative series. Last Comparative Example of Table 14B and 14C are identical conditions but give widely variable TS retention under AOA conditions.

TABLE 14D

| | Examples | | | |
|---|---|---|---|---|
| | C-51 | C-52 | C-53 | C-54 |
| PA 66 | 60.00 | 60.00 | 60.00 | 60.00 |
| Glass fiber A | 35.00 | 35.00 | 35.00 | 35.00 |
| Kemamide E180 | 0.10 | 0.10 | 0.10 | 0.10 |
| Copper heat stabilizer | 0.30 | 0.30 | 0.30 | 0.30 |
| Black pigment A | 0.60 | 0.60 | 0.60 | 0.60 |
| Black pigment B | 1.00 | 1.00 | 1.00 | 1.00 |
| TTE (method 2) | 1.50 | 1.50 | 1.50 | 1.50 |
| DDDA | 1.50 | 1.50 | 1.50 | 1.50 |

Tensile Properties, Dry-As Molded

| | | | | |
|---|---|---|---|---|
| TS [MPa] | 212 | 212 | 212 | 214 |
| EB [%] | 4.5 | 4.7 | 4.6 | 4.8 |

AOA, 500 h at 230° C.

| | | | | |
|---|---|---|---|---|
| TS [MPa] | 160 | 218 | 132 | 136 |
| TS Retention [%] | 75% | 103% | 62% | 64% |
| EB [%] | 3.0 | 4.8 | 2.8 | 4.0 |
| EB Retention [%] | 67% | 102% | 61% | 84% |

AOA, 1000 h at 230° C.

| | | | | |
|---|---|---|---|---|
| TS [MPa] | 174 | 176 | 73 | 33 |
| TS Retention [%] | 82% | 83% | 34% | 15% |
| EB [%] | 3.6 | 3.6 | 1.2 | 0.7 |
| EB Retention [%] | 80% | 75% | 25% | 14% |

Melt Viscosity @ 290° C.

| | | | | |
|---|---|---|---|---|
| MV @ 5 min | 117 | 128 | 117 | 221 |
| MV @ 25 min | 71 | 73 | 65 | 101 |
| % MV Retention | 61% | 57% | 56% | 46% |

Process conditions

| | | | | |
|---|---|---|---|---|
| Mass Flow Rate (lb/h) | 225 | 225 | 325 | 175 |
| Screw Speed (RPM) | 500 | 300 | 500 | 300 |

40 mm extruder, 280° C. barrel temperature.

Table 14D Comparative Examples were representative of the performance of PA 66 resin, absent a second polyamide resin. The polyepoxy compound (TTE) had an epoxy equivalent weight of about 138-154. PA 66 showed variable TS retention after 230° C./1000 h AOA under several processing conditions with constant level of polyepoxy compound and carboxylic acid compound within the same iterative series.

TABLE 14E

| | Examples | | | | |
|---|---|---|---|---|---|
| | 35 | 36 | 37 | 38 | 39 |
| PA 66 | 58.00 | 58.00 | 58.00 | 58.00 | 58.00 |
| Glass fiber A | 35.00 | 35.00 | 35.00 | 35.00 | 35.00 |
| Kemamide E180 | 0.10 | 0.10 | 0.10 | 0.10 | 0.10 |
| Copper heat stabilizer | 0.30 | 0.30 | 0.30 | 0.30 | 0.30 |
| Black pigment A | 0.60 | 0.60 | 0.60 | 0.60 | 0.60 |
| Black pigment B | 1.00 | 1.00 | 1.00 | 1.00 | 1.00 |
| Epon 1002F | 4.00 | 4.00 | 4.00 | 4.00 | 4.00 |
| DDDA | 1.00 | 1.00 | 1.00 | 1.00 | 1.00 |

Tensile Properties, Dry-As Molded

| | | | | | |
|---|---|---|---|---|---|
| TS [MPa] | 205 | 204 | 196 | 202 | 190 |
| EB [%] | 4.7 | 4.8 | 4.6 | 4.3 | 4.1 |

AOA, 500 h at 230° C.

| | | | | | |
|---|---|---|---|---|---|
| TS [MPa] | 151 | 142 | 145 | 145 | 146 |
| TS Retention [%] | 73% | 70% | 74% | 72% | 77% |
| EB [%] | 4.1 | 4.1 | 3.9 | 3.8 | 3.8 |
| EB Retention [%] | 87% | 85% | 85% | 89% | 92% |

AOA, 1000 h at 230° C.

| | | | | | |
|---|---|---|---|---|---|
| TS [MPa] | 102 | 82 | 98 | 101 | 97 |
| TS Retention [%] | 49% | 40% | 50% | 50% | 51% |
| EB [%] | 2.8 | 2.4 | 3.0 | 3.2 | 3.1 |
| EB Retention [%] | 59% | 50% | 65% | 76% | 76% |

Melt Viscosity @ 290° C.

| | | | | | |
|---|---|---|---|---|---|
| MV @ 5 min | 172 | 143 | 152 | 158 | 152 |
| MV @ 25 min | 130 | 114 | 115 | 122 | 118 |
| % MV Retention | 76% | 80% | 76% | 77% | 78% |

Process conditions

| | | | | | |
|---|---|---|---|---|---|
| Mass Flow Rate (lb/h) | 175 | 225 | 225 | 325 | 350 |
| Screw Speed (RPM) | 300 | 300 | 500 | 500 | 500 |

40 mm extruder, 280° C. barrel temperature.

Table 14E Comparative Examples were representative of the performance of PA 66 resin, absent a second polyamide resin. The polyepoxy compound (Epon 1002F) had an epoxy equivalent weight of about 600-700. PA 66 composition showed consistent TS retention after 230° C./1000 h AOA under several processing conditions with constant level of polyepoxy compound and carboxylic acid compound within the same iterative series.

TABLE 15A
(Blend Controls)

| | Examples | | | |
|---|---|---|---|---|
| | C-55 | C-56 | C-57 | C-58 |
| PA 66 | | | 58.00 | 58.00 |
| PA 66/6T | 58.00 | 58.00 | | |
| PA 6 | 5.00 | 5.00 | 5.00 | 5.00 |
| Glass fiber A | 35.00 | 35.00 | 35.00 | 35.00 |
| Kemamide E180 | 0.10 | 0.10 | 0.10 | 0.10 |
| Copper heat stabilizer | 0.30 | 0.30 | 0.30 | 0.30 |
| Black pigment A | 0.60 | 0.60 | 0.60 | 0.60 |
| Black pigment B | 1.00 | 1.00 | 1.00 | 1.00 |

Tensile Properties, Dry-As Molded

| | | | | |
|---|---|---|---|---|
| TS [MPa] | 191 | 210 | 208 | 209 |
| EB [%] | 5.4 | 5.5 | 5.7 | 5.7 |

AOA, 500 h at 230° C.

| | | | | |
|---|---|---|---|---|
| TS [MPa] | 113 | 147 | 72 | 63 |
| TS Retention [%] | 59% | 70% | 35% | 30% |
| EB [%] | 2.8 | 3.7 | 2.2 | 2.1 |
| EB Retention [%] | 52% | 66% | 38% | 38% |

AOA, 1000 h at 230° C.

| | | | | |
|---|---|---|---|---|
| TS [MPa] | 17 | 13 | 24 | 0 |
| TS Retention [%] | 9% | 6% | 12% | 0% |
| EB [%] | 0 | 0.3 | 1 | 0.0 |
| EB Retention [%] | 6% | 5% | 20% | 0% |

30 mm extruder, 30 lb/h, 300 rpm, 280° C. barrel temperature.

Table 15A Comparative Examples were representative of the performance of PA 66 or PA 66/6T resin blends with PA 6, absent polyepoxy compound and carboxylic acid compound. Both PA 66+PA 6 blend and PA 66/6T+PA 6 blend showed no more than 12% TS retention after 230° C./1000 h AOA under identical processing conditions.

TABLE 15B

| Examples | C-59 | C-60 | C-61 | C-62 | C-63 | C-64 |
|---|---|---|---|---|---|---|
| PA 66 | 58.00 | 58.00 | 58.00 | 58.00 | 58.00 | 58.00 |
| PA 6 | 5.00 | 5.00 | 5.00 | 5.00 | 5.00 | 5.00 |
| Glass fiber A | 35.00 | 35.00 | 35.00 | 35.00 | 35.00 | 35.00 |
| Kemamide | 0.10 | 0.10 | 0.10 | 0.10 | 0.10 | 0.10 |
| E180 | | | | | | |
| Copper heat | 0.30 | 0.30 | 0.30 | 0.30 | 0.30 | 0.30 |
| stabilizer | | | | | | |
| Black pigment | 0.60 | 0.60 | 0.60 | 0.60 | 0.60 | 0.60 |
| A | | | | | | |
| Black pigment | 1.00 | 1.00 | 1.00 | 1.00 | 1.00 | 1.00 |
| B | | | | | | |

Tensile Properties, Dry-As Molded

| | | | | | | |
|---|---|---|---|---|---|---|
| TS [MPa] | 199 | 199 | 195 | 198 | 196 | 195 |
| EB [%] | 5.7 | 5.3 | 5.3 | 5.4 | 5.4 | 5.6 |

AOA, 500 h at 230° C.

| | | | | | | |
|---|---|---|---|---|---|---|
| TS [MPa] | 0 | 0 | 0 | 0 | 0 | 0 |
| TS Retention | 0% | 0% | 0% | 0% | 0% | 0% |
| [%] | | | | | | |
| EB [%] | 0 | 0 | 0 | 0 | 0 | 0 |
| EB Retention | 0% | 0% | 0% | 0% | 0% | 0% |
| [%] | | | | | | |

AOA, 1000 h at 230° C.

| | | | | | | |
|---|---|---|---|---|---|---|
| TS [MPa] | 0 | 0 | 0 | 0 | 0 | 0 |
| TS Retention | 0% | 0% | 0% | 0% | 0% | 0% |
| [%] | | | | | | |
| EB [%] | 0 | 0 | 0 | 0 | 0 | 0 |
| EB Retention | 0% | 0% | 0% | 0% | 0% | 0% |
| [%] | | | | | | |

Melt Viscosity @ 290° C.

| | | | | | | |
|---|---|---|---|---|---|---|
| MV @ 5 min | 245 | 266 | 245 | 247 | 240 | 248 |
| MV @ 25 min | 203 | 226 | 215 | 214 | 207 | 218 |
| % MV | 83% | 85% | 88% | 87% | 86% | 88% |
| Retention | | | | | | |

Process conditions

| | | | | | | |
|---|---|---|---|---|---|---|
| Mass Flow | 175 | 175 | 225 | 225 | 325 | 350 |
| Rate (lb/h) | | | | | | |
| Screw Speed | 300 | 300 | 300 | 500 | 500 | 500 |
| (RPM) | | | | | | |

40 mm extruder, 280° C. barrel temperature.

Table 15B Comparative Examples were representative of the performance of PA 66+PA 6 resin blend, absent polyepoxy compound and carboxylic acid compound, under a variety of process conditions.

TABLE 16

| | Examples | | | | |
|---|---|---|---|---|---|
| | 40 | 41 | 42 | 43 | 44 |
| PA66 | 55.25 | 55.00 | 55.00 | 55.00 | 55.00 |
| PA6 | 5.00 | 5.00 | 5.00 | 5.00 | 5.00 |
| Glass fiber A | 35.00 | 35.00 | 35.00 | 35.00 | 35.00 |
| Kemamide E180 | 0.10 | 0.10 | 0.10 | 0.10 | 0.10 |
| Copper heat stabilizer | 0.30 | 0.30 | 0.30 | 0.30 | 0.30 |
| Black pigment A | 0.60 | 0.60 | 0.60 | 0.60 | 0.60 |
| Black pigment B | 1.00 | 1.00 | 1.00 | 1.00 | 1.00 |
| TTE (method 2) | 1.25 | 1.50 | 1.50 | 1.50 | 1.50 |
| DDDA | 1.50 | 1.50 | 1.50 | 1.50 | 1.50 |

Tensile Properties, Dry-As Molded

| | | | | | |
|---|---|---|---|---|---|
| Tensile Strength [MPa] | 202 | 214 | 210 | 211 | 211 |
| Elongation at Break [%] | 5.0 | 5.0 | 4.9 | 4.8 | 4.8 |

AOA, 500 h at 230° C.

| | | | | | |
|---|---|---|---|---|---|
| Tensile Strength [MPa] | 209 | 220 | 212 | 222 | 216 |
| Tensile Strength | 104% | 103% | 101% | 105% | 102% |
| Retention [%] | | | | | |
| Elongation at Break [%] | 4.8 | 5.0 | 4.7 | 4.9 | 4.8 |
| Elongation at Break | 97% | 100% | 95% | 102% | 101% |
| Retention [%] | | | | | |

AOA, 1000 h at 230° C.

| | | | | | |
|---|---|---|---|---|---|
| Tensile Strength [MPa] | 197 | 157 | 175 | 168 | 170 |
| Tensile Strength | 97% | 73% | 83% | 79% | 81% |
| Retention [%] | | | | | |
| Elongation at Break [%] | 4.3 | 3.6 | 4.2 | 3.7 | 3.7 |
| Elongation at Break | 86% | 72% | 85% | 78% | 78% |
| Retention [%] | | | | | |

Melt Viscosity @ 290° C.

| | | | | | |
|---|---|---|---|---|---|
| MV @ 5 min | 115.0 | 137 | 244 | 113 | 90 |
| MV @ 25 min | 74.0 | 67 | 88 | 71 | 69 |
| % MV Retention | 64% | 49% | 36% | 63% | 77% |

Process conditions

| | | | | | |
|---|---|---|---|---|---|
| Mass Flow Rate (lb/h) | 300 | 175 | 225 | 225 | 325 |
| Screw Speed (RPM) | 500 | 300 | 300 | 500 | 500 |

40 mm extruder, 280° C. barrel temperature.

Table 16 Examples were representative of the performance of PA 66+PA 6 resin blend, in the presence of TTE and ODDA, under a variety of process conditions. TS retention under AOA conditions (1000 h at 230° C.) ranged from 73% to 97%. These results are surprising and unexpected in view of the wide variation in results for PA 66, absent PA 6, illustrated in Tables 14C and 14 D. The PA 66+PA 6 blends exhibit a significantly broader process window than PA 66 alone.

TABLE 17

| | Examples | | | | |
|---|---|---|---|---|---|
| | 45 | 46 | 47 | 48 | 49 |
| PA66 | 53.00 | 53.00 | 53.00 | 53.00 | 53.00 |
| PA6 | 5.00 | 5.00 | 5.00 | 5.00 | 5.00 |
| Glass fiber A | 35.00 | 35.00 | 35.00 | 35.00 | 35.00 |
| Kemamide E180 | 0.10 | 0.10 | 0.10 | 0.10 | 0.10 |
| Copper heat stabilizer | 0.30 | 0.30 | 0.30 | 0.30 | 0.30 |
| Black pigment A | 0.60 | 0.60 | 0.60 | 0.60 | 0.60 |
| Black pigment B | 1.00 | 1.00 | 1.00 | 1.00 | 1.00 |
| DDDA | 1.00 | 1.00 | 1.00 | 1.00 | 1.00 |
| EPON 1002F | 4.00 | 4.00 | 4.00 | 4.00 | 4.00 |

Tensile Properties, Dry-As Molded

| | | | | | |
|---|---|---|---|---|---|
| TS [MPa] | 199 | 197 | 198 | 194 | 194 |
| EB [%] | 4.7 | 4.6 | 4.5 | 4.4 | 4.4 |

AOA, 500 h at 230° C.

| | | | | | |
|---|---|---|---|---|---|
| TS [MPa] | 146 | 152 | 166 | 149 | 154 |
| TS Retention [%] | 73% | 77% | 84% | 77% | 79% |
| EB [%] | 3.7 | 3.9 | 3.8 | 3.7 | 4.1 |
| EB Retention [%] | 80% | 84% | 83% | 83% | 92% |

AOA, 1000 h at 230° C.

| | | | | | |
|---|---|---|---|---|---|
| TS [MPa] | 94 | 118 | 120 | 112 | 113 |
| TS Retention [%] | 47% | 60% | 60% | 58% | 58% |
| EB [%] | 2.5 | 3.2 | 3.3 | 3.1 | 3.0 |
| EB Retention [%] | 55% | 68% | 72% | 69% | 69% |

Melt Viscosity @ 290° C.

| | | | | | |
|---|---|---|---|---|---|
| MV @ 5 min | 165 | 202 | 143 | 158 | 148 |
| MV @ 25 min | 126 | 141 | 117 | 117 | 118 |
| % MV Retention | 76% | 70% | 82% | 74% | 80% |

Process conditions

| | | | | | |
|---|---|---|---|---|---|
| Mass Flow Rate (lb/h) | 175 | 225 | 225 | 325 | 350 |
| Screw Speed (RPM) | 300 | 300 | 500 | 500 | 500 |

40 mm extruder, 280° C. barrel temperature.

Table 17 Examples were representative of the performance of PA 66+PA 6 resin blend, in the presence of Epon 1002F, having epoxy equivalent weight of about 600-700, and DDDA, under a variety of process conditions. TS retention under AOA conditions (1000 h at 230° C.) ranged from 47% to 60%.

TABLE 18

| Examples | 50 | 51 | 52 | 53 | 54 | 55 |
|---|---|---|---|---|---|---|
| Polyamide B | 55.50 | 54.75 | 55.00 | 55.25 | 54.50 | 54.75 |
| (PA 66/6T) | | | | | | |
| PA 6 | 5.00 | 5.00 | 5.00 | 5.00 | 5.00 | 5.00 |
| Glass fiber A | 35.00 | 35.00 | 35.00 | 35.00 | 35.00 | 35.00 |
| Kemamide | 0.10 | 0.10 | 0.10 | 0.10 | 0.10 | 0.10 |
| E-180 | | | | | | |
| Black pigment | 0.60 | 0.60 | 0.60 | 0.60 | 0.60 | 0.60 |
| A | | | | | | |
| Black pigment | 1.00 | 1.00 | 1.00 | 1.00 | 1.00 | 1.00 |
| B | | | | | | |
| Copper heat | 0.30 | 0.30 | 0.30 | 0.30 | 0.30 | 0.30 |
| stabilizer | | | | | | |
| TTE | 1.25 | 1.50 | 1.50 | 1.50 | 1.75 | 1.50 |
| DDDA | 1.25 | 1.75 | 1.50 | 1.25 | 1.75 | 1.75 |

Tensile Properties, Dry-As-molded

| | | | | | | |
|---|---|---|---|---|---|---|
| TS [MPa] | 203 | 203 | 201 | 199 | 198 | 201 |
| EB [%] | 5 | 5 | 5 | 5 | 5 | 5 |

AOA, 500 h at 230° C.

| | | | | | | |
|---|---|---|---|---|---|---|
| TS [MPa] | 176 | 196 | 205 | 199 | 199 | 201 |
| TS Retention | 87% | 96% | 102% | 100% | 100% | 100% |
| EB [%] | 3.9 | 4.3 | 4.7 | 4.6 | 4.6 | 4.8 |
| EB Retention | 74% | 90% | 94% | 91% | 95% | 96% |

AOA, 1000 h at 230° C.

| | | | | | | |
|---|---|---|---|---|---|---|
| TS [MPa] | 104 | 104 | 106 | 100 | 176 | 166 |
| TS Retention | 57% | 51% | 53% | 50% | 88% | 83% |
| EB [%] | 3.1 | 2.5 | 2.1 | 2.6 | 3.6 | 3.7 |
| EB Retention | 59% | 52% | 41% | 51% | 75% | 74% |

Melt Viscosity @ 290° C.

| | | | | | | |
|---|---|---|---|---|---|---|
| MV @ 5 min | 145 | 98 | 129 | 121 | 91 | 103 |
| [Pa · s] | | | | | | |
| MV @ 25 min | 91 | 69 | 82 | 86 | 65 | 71 |
| [Pa · s] | | | | | | |
| MV Retention | 63% | 70% | 64% | 71% | 71% | 69% |

40 mm extruder, 350 lb/h, 500 rpm, 280° C. barrel temperature.

Table 18 Examples were representative of the performance of PA 66/6T+PA 6 resin blend, in the presence of TTE and DDDA, in iterative runs under similar process conditions. TS retention under AOA conditions (1000 h at 230° C.) was level at about 50% except at higher DDDA levels.

TABLE 19

| Examples | 56 | 57 | 58 | 59 | C-65 | C-66 | 60 |
|---|---|---|---|---|---|---|---|
| PA66 | 60.25 | 57.24 | 45.19 | 30.13 | 7.53 | 3.01 | 0.00 |
| Polyamide B (PA | 0.00 | 3.01 | 15.06 | 30.13 | 52.72 | 57.24 | 60.25 |
| 66/6T) | | | | | | | |
| Glass fiber A | 35.00 | 35.00 | 35.00 | 35.00 | 35.00 | 35.00 | 35.00 |
| Kemamide E180 | 0.10 | 0.10 | 0.10 | 0.10 | 0.10 | 0.10 | 0.10 |
| Copper heat stabilizer | 0.30 | 0.30 | 0.30 | 0.30 | 0.30 | 0.30 | 0.30 |
| Black pigment A | 0.60 | 0.60 | 0.60 | 0.60 | 0.60 | 0.60 | 0.60 |
| Black pigment B | 1.00 | 1.00 | 1.00 | 1.00 | 1.00 | 1.00 | 1.00 |
| TTE (method 2) | 1.25 | 1.25 | 1.25 | 1.25 | 1.25 | 1.25 | 1.25 |
| DDDA | 1.50 | 1.50 | 1.50 | 1.50 | 1.50 | 1.50 | 1.50 |

Tensile Properties, Dry-As Molded

| | | | | | | | |
|---|---|---|---|---|---|---|---|
| TS [MPa] | 210 | 215 | 207 | 203 | 190 | 192 | 193 |
| EB [%] | 4.8 | 5.1 | 5.1 | 5.3 | 5.6 | 5.5 | 5.5 |

AOA, 500 h at 230° C.

| | | | | | | | |
|---|---|---|---|---|---|---|---|
| TS [MPa] | 202 | 187 | 130 | 120 | 132 | 134 | 171 |
| TS Retention [%] | 96% | 87% | 63% | 59% | 70% | 70% | 89% |
| EB [%] | 4.2 | 4.1 | 2.9 | 2.8 | 4.1 | 3.2 | 4.1 |
| EB Retention [%] | 89% | 82% | 57% | 52% | 73% | 58% | 74% |

AOA, 1000 h at 230° C.

| | | | | | | | |
|---|---|---|---|---|---|---|---|
| TS [MPa] | 144 | 128 | 120 | 136 | 27 | 42 | 149 |
| TS Retention [%] | 69% | 60% | 58% | 67% | 14% | 22% | 77% |
| EB [%] | 3.1 | 2.9 | 2.8 | 3.4 | 0.5 | 1.1 | 3.8 |
| EB Retention [%] | 65% | 58% | 54% | 64% | 8% | 20% | 70% |

Melt Viscosity @ 290° C.

| | | | | | | | |
|---|---|---|---|---|---|---|---|
| MV @ 5 min [Pa · s] | 87 | 122 | 101 | 106 | 252 | 180 | 223 |
| MV @ 25 min [Pa · s] | 77 | 86 | 77 | 79 | 153 | 124 | 154 |
| % MV Retention | 89% | 70% | 76% | 75% | 61% | 69% | 69% |

30 mm extruder, 40 lb/h, 400 rpm, 290° C. barrel temperature.

Table 19 Examples were representative of the performance of PA 66+PA 6616T resin blends, in the presence of constant levels of TTE and DDDA, in iterative runs under similar process conditions.

TABLE 20

| Examples | 61 | 62 | 63 | 64 | 65 | 66 | 67 |
|---|---|---|---|---|---|---|---|
| PA66 | 0.00 | 2.76 | 6.91 | 27.63 | 41.44 | 52.49 | 55.25 |
| Polyamide B (PA | 55.25 | 52.49 | 48.34 | 27.63 | 13.81 | 2.76 | 0.00 |
| 66/6T) | | | | | | | |
| PA6 | 5.00 | 5.00 | 5.00 | 5.00 | 5.00 | 5.00 | 5.00 |
| Glass fiber A | 35.00 | 35.00 | 35.00 | 35.00 | 35.00 | 35.00 | 35.00 |
| Kemamide E180 | 0.10 | 0.10 | 0.10 | 0.10 | 0.10 | 0.10 | 0.10 |
| Copper heat stabilizer | 0.30 | 0.30 | 0.30 | 0.30 | 0.30 | 0.30 | 0.30 |
| Black pigment A | 0.60 | 0.60 | 0.60 | 0.60 | 0.60 | 0.60 | 0.60 |
| Black pigment B | 1.00 | 1.00 | 1.00 | 1.00 | 1.00 | 1.00 | 1.00 |
| TTE (method 2) | 1.25 | 1.25 | 1.25 | 1.25 | 1.25 | 1.25 | 1.25 |
| DDDA | 1.50 | 1.50 | 1.50 | 1.50 | 1.50 | 1.50 | 1.50 |

Tensile Properties, Dry-As Molded

| | | | | | | | |
|---|---|---|---|---|---|---|---|
| TS [MPa] | 190 | 192 | 193 | 199 | 204 | 209 | 213 |
| EB [%] | 5.5 | 5.7 | 4.8 | 5.5 | 5.0 | 5.0 | 5.3 |

AOA, 500 h at 230° C.

| | | | | | | | |
|---|---|---|---|---|---|---|---|
| TS [MPa] | 127 | 130 | 124 | 124 | 128 | 103 | 102 |
| TS Retention [%] | 67% | 68% | 64% | 62% | 63% | 49% | 48% |
| EB [%] | 2.8 | 3.0 | 2.8 | 3.1 | 3.0 | 2.3 | 2.0 |
| EB Retention [%] | 50% | 52% | 59% | 56% | 60% | 46% | 38% |

AOA, 1000 h at 230° C.

| | | | | | | | |
|---|---|---|---|---|---|---|---|
| TS [MPa] | 139 | 127 | 176 | 125 | 159 | 189 | 144 |
| TS Retention [%] | 73% | 66% | 91% | 63% | 78% | 90% | 68% |
| EB [%] | 3.5 | 3.1 | 4.8 | 3.3 | 4.8 | 5.0 | 3.7 |
| EB Retention [%] | 64% | 55% | 99% | 59% | 95% | 101% | 69% |

Melt Viscosity @ 290° C.

| | | | | | | | |
|---|---|---|---|---|---|---|---|
| MV @ 5 min [Pa · s] | 122 | 179 | 104 | 110 | 90 | 84 | 92 |
| MV @ 25 min [Pa · s] | 88 | 105 | 90 | 82 | 65 | 71 | 74 |
| % MV Retention | 72% | 59% | 87% | 75% | 72% | 85% | 80% |

30 mm extruder, 40 lb/h, 400 rpm, 290° C. barrel temperature.

Table 20 Examples were representative of the performance of PA 66+PA 66/6T+PA 6 resin blends, in the presence of constant levels of TTE and DDDA, in iterative runs under similar process conditions.

We claim:

1. A thermoplastic melt-mixed composition comprising:
a) 15 to 89.5 weight percent of a semi-crystalline polyamide resin selected from the group consisting of bends of semi-crystalline polyamides; Group (III) polyamides having a melting point of at least 230° C., and comprising
(aa) about 20 to about 35 mole percent semi-aromatic repeat units derived from monomers selected from one or more of the group consisting of:
(i) aromatic dicarboxylic acids having 8 to 20 carbon atoms and aliphatic diamines having 4 to 20 carbon atoms; and
(bb) about 65 to about 80 mole percent aliphatic repeat units derived from monomers selected from one or more of the group consisting of:
(ii) an aliphatic dicarboxylic acid having 6 to 20 carbon atoms and said aliphatic diamine having 4 to 20 carbon atoms; and
(iii) a lactam and/or aminocarboxylic acid having 4 to 20 carbon atoms; and
Group (IV) polyamides comprising
(cc) about 50 to about 95 mole percent semiaromatic repeat units derived from monomers selected from one or more of the group consisting of:
(i) aromatic dicarboxylic acids having 8 to 20 carbon atoms and aliphatic diamines having 4 to 20 carbon atoms; and
(dd) about 5 to about 50 mole percent aliphatic repeat units derived from monomers selected from one or more of the group consisting of:
(ii) an aliphatic dicarboxylic acid having 6 to 20 carbon atoms and said aliphatic diamine having 4 to 20 carbon atoms; and
(iii) a lactam and/or aminocarboxylic acid having 4 to 20 carbon atoms;
b) 0.50 to 5.0 weight percent (preferably 0.5 to 4.0, 1.0 to 4.0 and 1.0 to 3.0 weight percent) of one or more polyepoxy compound(s) comprising at least two to five (preferably 2 to 4.5 and 2 to 4) epoxy groups, on average, per molecule; the polyepoxy compound having an epoxide equivalent weight of 43 to 4000 g/equivalent (preferably 70 to 200, 70 to 190 and 70 to 180 g/equivalent, last two ranges are new matter) as determined by calculation, or if the polyepoxy compound is an oligomer, by titration using ASTM D1652-11 method; and a number average molecular weight of less than 8000;
c) about 0.25 to 5.0 weight percent (preferably 0.5 to 4.0, 1.0 to 4.0 1.0 to 3.0 weight percent) of one or more carboxylic acid compounds having melting points of less than 280° C., (preferably a melting point of less than 250° C., selected from the group consisting of polyacids, acid alcohols and combinations of these, the carboxylic acid compounds having a number average molecular weight of less than 2000;
d) 10 to 60 weight percent of reinforcing agent;
e) 0 to 30 weight percent polymeric toughener; and
f) 0 to 10 weight percent of further additives;
wherein the weight per cents of components a), b), c) d) and e) are based on the total weight of the thermoplastic melt-mixed composition and wherein 2 mm thick test bars, prepared from said melt-mixed composition and exposed at a test temperature of 230° C. for a test period of 1000 hours, in an atmosphere of air, and tested according to ISO 527-2/1BA, have on average, a retention of tensile strength of at least 30 percent, as compared with that of an unexposed control of identical composition and shape.

2. The thermoplastic melt-mixed composition of claim 1 wherein the semi-crystalline polyamide resin is a Group (Ill) polyamide and is poly(hexamethylene hexanediamide/hexamethylene terephthalamide) (PA66/6T).

3. The thermoplastic melt-mixed composition of claim 1 wherein the semi-crystalline polyamide resin is a blend of semi-crystalline polyamides selected from the group consisting of poly(hexamethylene hexanediamide) and poly(hexamethylene hexanediamide/hexamethylene terephthalamide (PA 66+PA 66/6T); poly(hexamethylene hexanediamide) and poly(caprolactam) (PA 66+PA 6); poly(hexamethylene hexanediamidelhexamethylene terephthalamide and poly(caprolactam) (PA 66/6T+PA 6) and poly(hexamethylene hexanediamide), poly(hexamethylene hexanediamide/hexamethylene terephthalamide and poly(caprolactam) (PA 66+PA 66/6T+PA 6).

4. The thermoplastic melt-mixed composition of claim 1 wherein the one or more polyepoxy compound(s) has an epoxide equivalent weight of 70 to 200.

5. The thermoplastic melt-mixed composition of claim 4 wherein the one or more polyepoxy compound(s) is trimethylolpropane triglycidyl ether (TTE).

6. The thermoplastic melt-mixed composition of claim 4 wherein the one or more carboxylic acid compounds have a melting point of less than 250° C.

7. The thermoplastic melt-mixed composition of claim 6 wherein the polyacid is selected from the group consisting of decanedioic acid and dodecanedioic acid (DDDR).

8. The thermoplastic melt-mixed composition of claim 1 wherein the semi-crystalline polyamide resin is poly(hexamethylene hexanediamide/hexamethylene terephthalamide) (PA66/6T); the reinforcing agent is selected from the group consisting of glass fiber and glass fiber with noncircular cross-section, and mixtures of these; the one or more polyepoxy compound(s) is trimethylolpropane triglycidyl ether (TTE) and is present at 1.0 to 3.0 weight percent; and the polyacid is selected from the group consisting of decanedioic acid and dodecanedioic acid (DDDR) and present at 0.5 to 3.0 weight percent; and the weight ratio of trimethylolpropane triglycidyl ether to polyacid is 0.5:1 to 3:1.

9. A process for providing a thermoplastic melt-mixed composition comprising:
A) melt-blending:
a) 15 to 89.5 weight percent of a semi-crystalline polyamide resin selected from the group consisting of blends of semi-crystalline polyamides; Group (III) polyamides having a melting point of at least 230° C., and comprising
(aa) about 20 to about 35 mole percent semi-aromatic repeat units derived from monomers selected from one or more of the group consisting of:
(i) aromatic dicarboxylic acids having 8 to 20 carbon atoms and aliphatic diamines having 4 to 20 carbon atoms; and
(bb) about 65 to about 80 mole percent aliphatic repeat units derived from monomers selected from one or more of the group consisting of:
(ii) an aliphatic dicarboxylic acid having 6 to 20 carbon atoms and said aliphatic diamine having 4 to 20 carbon atoms; and
(iii) a lactam and/or aminocarboxylic acid having 4 to 20 carbon atoms; and
Group (IV) polyamides comprising
(cc) about 50 to about 95 mole percent semiaromatic repeat units derived from monomers selected from one or more of the group consisting of:
(i) aromatic dicarboxylic acids having 8 to 20 carbon atoms and aliphatic diamines having 4 to 20 carbon atoms; and
(dd) about 5 to about 50 mole percent aliphatic repeat units derived from monomers selected from one or more of the group consisting of:
(ii) an aliphatic dicarboxylic acid having 6 to 20 carbon atoms and said aliphatic diamine having 4 to 20 carbon atoms; and
(iii) a lactam and/or aminocarboxylic acid having 4 to 20 carbon atoms;
c) about 0.25 to 5.0 weight percent of one or more carboxylic acid compounds having melting points of less than 280° C. selected from the group consisting of polyacids, acid alcohols and combinations of these, the carboxylic acid compounds having a number average molecular weight of less than 2000;
d) 10 to 60 weight percent of reinforcing agent;
e) 0 to 30 weight percent polymeric toughener; and
f) 0 to 10 weight percent of further additives;
to provide a polyamide-polyacid blend; and
B) melt-blending said polyamide-polyacid blend with
b) 0.5 to 5.0 weight percent of one or more polyepoxy compound(s) comprising at least two to five epoxy groups, on average, per molecule; the polyepoxy compound having an epoxide equivalent weight of 43 to 4000 g/equivalent as determined by calculation, or if the polyepoxy compound is an oligomer, by titration using ASTM 01652-11 method; and a number average molecular weight of less than 8000; and
wherein the weight percents of components a), b), c), d) e) and f) are based on the total weight of the thermoplastic melt-mixed composition.

10. The process of claim 9 wherein the thermoplastic melt-mixed composition has a melt viscosity at a hold time of 25 minutes less than 600% of the melt viscosity at a hold time of 5 minutes; as measured at temperature 10° C. to 30° C. above the melting point of the polyamide resin, in a capillary rheometer at a shear rate of 1000 sec⁻¹ according to ASTM 03835.

11. The process of claim 9 wherein one or more of components c), d), e) and f) are melt-blended with said polyamide-polyacid blend in step B).

12. The process of claim 9 wherein melt-blending said polyamide-polyacid blend with component b) is provided by metering in said one or more polyepoxy compound by pump into said polyamide-polyacid blend.

13. The process of claim 9 wherein the one or more polyepoxy compounds(s) has an epoxide equivalent weight of 70 to 200.

14. The process of claim 9 wherein the one or more carboxylic acid compounds have a melting point of less than 250° C.

15. A process for providing a thermoplastic melt-mixed composition comprising;
A) melt-blending:
a) 15 to 89.5 weight percent of a semi-crystalline polyamide resin selected from the group consisting of blends of semi-crystalline polyamides; Group (III) polyamides having a melting point of at least 230° C., and comprising
(aa) about 20 to about 35 mole percent semi-aromatic repeat units derived from monomers selected from one or more of the group consisting of:
(i) aromatic dicarboxylic acids having 8 to 20 carbon atoms and aliphatic diamines having 4 to 20 carbon atoms; and
(bb) about 65 to about 80 mole percent aliphatic repeat units derived from monomers selected from one or more of the group consisting of:
(ii) an aliphatic dicarboxylic acid having 6 to 20 carbon atoms and said aliphatic diamine having 4 to 20 carbon atoms; and
(iii) a lactam and/or aminocarboxylic acid having 4 to 20 carbon atoms; and
Group (IV) polyamides comprising
(cc) about 50 to about 95 mole percent semiaromatic repeat units derived from monomers selected from one or more of the group consisting of:
(i) aromatic dicarboxylic acids having 8 to 20 carbon atoms and aliphatic diamines having 4 to 20 carbon atoms; and
(dd) about 5 to about 50 mole percent aliphatic repeat units derived from monomers selected from one or more of the group consisting of:
(ii) an aliphatic dicarboxylic acid having 6 to 20 carbon atoms and said aliphatic diamine having 4 to 20 carbon atoms; and
(iii) a lactam and/or aminocarboxylic acid having 4 to 20 carbon atoms;
b) 0.5 to 5.0 weight percent of one or more polyepoxy compound(s) comprising at least two to five epoxy groups, on average, per molecule; the polyepoxy compound having an epoxide equivalent weight of 43 to 4000 g/equivalent as determined by calculation, or if the polyepoxy compound is an oligomer, by titration using ASTM D1652-11 method; and a number average molecular weight (Mₙ) of less than 8000;
c) about 0.25 to 5.0 weight percent of one or more carboxylic acid compounds having melting points of less than 280° C., selected from the group consisting of polyacids, acid alcohols and combinations of these, the carboxylic acid compounds having a number average molecular weight of less than 2000;
d) 10 to 60 weight percent of reinforcing agent;
e) 0 to 30 weight percent polymeric toughener; and
f) 0 to 10 weight percent of further additives;
wherein the weight percents of components a), b), c), d) e) and f) are based on the total weight of the thermoplastic melt-mixed composition and wherein components b) polyepoxy compound and c) carboxylic acid compounds are added simultaneously during the melt-blending.

16. The process of claim 15 wherein the thermoplastic melt-mixed composition has a melt viscosity at a hold time of 25 minutes less than 600% of the melt viscosity at a hold time of 5 minutes; as measured at temperature 10° C. to 30° C. above the melting point of the polyamide resin, in a capillary rheometer at a shear rate of 1000 sec⁻¹ according to ASTM 03835.

17. The process of claim 15 wherein the one or more polyepoxy compounds(s) have an epoxide equivalent weight of 70 to 200.

18. The process of claim 15 wherein the one or more carboxylic acid compounds have a melting point of less than 250° C.

19. A thermoplastic melt-mixed composition comprising:
a) 15 to 89.5 weight percent of poly(hexamethylene hexanediamide);
b) 0.50 to 5.0 weight percent of one or more polyepoxy compound(s) comprising at least two to five epoxy groups, on average, per molecule; the polyepoxy compound having an epoxide equivalent weight of 210-1200 g/equivalent as determined by calculation, or if the polyepoxy compound is an oligomer, by titration using ASTM D1652-11 method; and a number average molecular weight of less than 8000;
c) about 0.25 to 5.0 weight percent of one or more carboxylic acid compounds, having melting points of less than 280° C., selected from the group consisting of polyacids, acid alcohols and combinations of these, the carboxylic acid compounds having a number average molecular weight of less than 2000;
d) 10 to 60 weight percent of reinforcing agent;
e) 0 to 30 weight percent polymeric toughener; and
f) 0 to 10 weight percent of further additives;
wherein the weight per cents of components a), b), c) d) and e) are based on the total weight of the thermoplastic melt-mixed composition and wherein 2 mm thick test bars, prepared from said melt-mixed composition and exposed at a test temperature of 230° C. for a test period of 1000 hours, in an atmosphere of air, and tested according to ISO 527-2/1 BA, have on average, a retention of tensile strength of at least 30 percent, as compared with that of an unexposed control of identical composition and shape.
